(19) United States
(12) Patent Application Publication
(10) Pub. No.: US 2025/0162668 A1
(43) Pub. Date: May 22, 2025

(54) CALCULATION DEVICE, CALCULATION SYSTEM, AND CALCULATION METHOD

(71) Applicant: TOYOTA JIDOSHA KABUSHIKI KAISHA, Toyota-shi (JP)

(72) Inventors: Yasuyoshi HATANO, Nisshin-shi (JP); Kento IWAHORI, Nisshin-shi (JP); Daiki YOKOYAMA, Miyoshi-shi (JP); Yasuhiro SAITO, Toyoake-shi (JP)

(73) Assignee: TOYOTA JIDOSHA KABUSHIKI KAISHA, Toyota-shi (JP)

(21) Appl. No.: 18/915,959

(22) Filed: Oct. 15, 2024

(30) Foreign Application Priority Data
Nov. 22, 2023 (JP) 2023-198209

(51) Int. Cl. B62D 65/18; G06T 7/00; G06T 7/73

(52) U.S. Cl. CPC B62D 65/18; G06T 7/0002; G06T 7/74; G06T 2207/10028; G06T 2207/30108; G06T 2207/30168

(57) ABSTRACT

A calculation device includes an acquisition unit configured to acquire three-dimensional point cloud data, a calculation unit configured to calculate at least either of a position and an orientation of a mobile object using the three-dimensional point cloud data, and at least one of (i) a prediction unit configured to predict that the three-dimensional point cloud data is expected to be defective, (ii) a detection unit configured to detect that the three-dimensional point cloud data is defective, and (iii) a determination unit configured to determine whether the mobile object is present in a specific area where the three-dimensional point cloud data is presumed in advance to be defective. The calculation unit is configured to execute at least a second calculation process when at least one of a first case, a second case, and a third case applies.

### CROSS-REFERENCE TO RELATED APPLICATION

This application claims priority to Japanese Patent Application No. 2023-198209 filed on Nov. 22, 2023, incorporated herein by reference in its entirety.

### BACKGROUND

### 1. Technical Field

The present disclosure relates to a calculation device, a calculation system, and a calculation method.

### 2. Description of Related Art

There is known a technology in which a vehicle is caused to travel autonomously or by remote control by monitoring the traveling of the vehicle using a LiDAR outside the vehicle (Japanese Unexamined Patent Application Publication (Translation of PCT Application) No. 2017-538619 (JP 2017-538619 A)).

### SUMMARY

To move a mobile object such as a vehicle by driverless operation, the position and orientation of the mobile object may be calculated using three-dimensional point cloud data indicating the mobile object and output from a mobile object detection device such as a LiDAR. If the three-dimensional point cloud data is defective due to the presence of an obstacle between the mobile object detection device and the mobile object, however, the accuracy of the position and orientation of the mobile object may decrease.

The present disclosure can be implemented as the following aspects.

(1) A first aspect of the present disclosure provides a calculation device. The calculation device includes:
an acquisition unit configured to acquire three-dimensional point cloud data indicating, by a point cloud, a mobile object movable by driverless operation;
a calculation unit configured to calculate at least either of a position and an orientation of the mobile object using the three-dimensional point cloud data; and
at least one of (i) a prediction unit configured to predict that the three-dimensional point cloud data is expected to be defective, (ii) a detection unit configured to detect that the three-dimensional point cloud data is defective, and (iii) a determination unit configured to determine whether the mobile object is present in a specific area where the three-dimensional point cloud data is presumed in advance to be defective.

The calculation unit is configured to execute a first calculation process of calculating at least either of the position and the orientation of the mobile object by comparing the three-dimensional point cloud data with reference point cloud data prepared in advance, and a second calculation process of calculating at least either of the position and the orientation of the mobile object by applying graphic data having a predetermined shape to the three-dimensional point cloud data.

The calculation unit is configured to execute at least the second calculation process when at least one of a first case, a second case, and a third case applies. The first case is a case where the prediction unit predicts that the three-dimensional point cloud data is expected to be defective. The second case is a case where the detection unit detects that the three-dimensional point cloud data is defective. The third case is a case where the determination unit determines that the mobile object is present in the specific area.

According to this aspect, the calculation device can calculate at least either of the position and the orientation of the mobile object using the three-dimensional point cloud data. At this time, the calculation device can accurately calculate the position and orientation of the mobile object by comparing the three-dimensional point cloud data with the reference point cloud data through the first calculation process. When at least one of the first case, the second case, and the third case applies, the accuracy of the position and orientation of the mobile object calculated by the first calculation process may decrease. The calculation device can calculate at least either of the position and the orientation of the mobile object by executing at least the second calculation process when at least one of the first case, the second case, and the third case applies. With this configuration, when at least one of the first case, the second case, and the third case applies, the calculation device can estimate information corresponding to the defective portion of the point cloud constituting the three-dimensional point cloud data by applying the graphic data to the three-dimensional point cloud data through the second calculation process. Thus, the calculation device can suppress the decrease in the accuracy of the position and orientation of the mobile object when at least one of the first case, the second case, and the third case applies.

(2) In the above aspect,
the prediction unit may be configured to predict that the three-dimensional point cloud data is expected to be defective using at least either of:
object information on at least either of an object present in a first area where a first manufacturing step is being executed on the mobile object and an object present in a second area where a second manufacturing step is to be executed on the mobile object; and
work information indicating whether a specific work is to be executed in at least either of the first manufacturing step and the second manufacturing step. The specific work is a work in which a work object that is at least either of a manufacturing device to be used in the at least either of the first manufacturing step and the second manufacturing step and a worker engaged in the work in the at least either of the first manufacturing step and the second manufacturing step enters at least either of an interior of the mobile object and a surrounding area around the mobile object to carry out the work.

According to this aspect, the calculation device can predict that the three-dimensional point cloud data is expected to be defective using at least either of the object information and the work information.

(3) In the above aspect,
the specific area may be an area where a specific work is executed. The specific work is a work in which a work object that is at least either of a manufacturing device to be used in a manufacturing step for the mobile object and a worker engaged in the work in the manufacturing step enters at least either of an interior of the mobile object and a surrounding area around the mobile object to carry out the work.

According to this aspect, the calculation device can determine whether the mobile object is present in the area where the specific work is executed. Thus, the calculation device can further suppress the decrease in the accuracy of the position and orientation of the mobile object in the third case.

(4) In the above aspect,
the detection unit may be configured to detect that the three-dimensional point cloud data is defective when a count of points constituting the three-dimensional point cloud data is smaller than a predetermined count.

According to this aspect, the calculation device can detect that the three-dimensional point cloud data is defective when the count of points constituting the three-dimensional point cloud data is smaller than the predetermined count.

(5) In the above aspect,
the detection unit may be configured to detect that the three-dimensional point cloud data is defective when an object is detected in the three-dimensional point cloud data between the mobile object and a mobile object detection device configured to output the three-dimensional point cloud data by detecting the mobile object from outside the mobile object.

According to this aspect, the calculation device can detect that the three-dimensional point cloud data is defective when an object is detected in the three-dimensional point cloud data between the mobile object and the mobile object detection device.

(6) In the above aspect,
the acquisition unit may be configured to acquire a plurality of pieces of the three-dimensional point cloud data detected at different timings for the same mobile object. The calculation unit may be configured to calculate at least either of the positions and the orientations of the mobile object at the different timings by executing the first calculation process on the pieces of the three-dimensional point cloud data, and generate time series data on at least either of the positions and the orientations of the mobile object by arranging at least either of the positions and the orientations of the mobile object in chronological order. The detection unit may be configured to detect, using the time series data, that at least one of the pieces of the three-dimensional point cloud data is defective.

The calculation unit may be configured to, when the detection unit detects that at least one of the pieces of the three-dimensional point cloud data is defective, calculate at least either of the position and the orientation of the mobile object by executing the second calculation process without executing the first calculation process.

According to this aspect, the calculation device can acquire a plurality of pieces of the three-dimensional point cloud data detected at different timings for the same mobile object. The calculation device can calculate at least either of the positions and the orientations of the mobile object at the different timings by executing the first calculation process on the acquired pieces of the three-dimensional point cloud data, and generate the time series data. Thus, the calculation device can detect, using the time series data, that at least one of the pieces of the three-dimensional point cloud data is defective. When the calculation device detects that at least one of the pieces of the three-dimensional point cloud data is defective, the calculation device can calculate at least either of the position and the orientation of the mobile object by executing the second calculation process without executing the first calculation process. With this configuration, the calculation device can further suppress the decrease in the accuracy of the position and orientation of the mobile object in the second case.

(7) In the above aspect,
when at least one of the first case, the second case, and the third case applies, the calculation unit may execute the first calculation process and the second calculation process,
the calculation unit may calculate the position of the mobile object by executing a first arithmetic process using the position of the mobile object calculated by executing the first calculation process and the position of the mobile object calculated by executing the second calculation process, and
the calculation unit may calculate the orientation of the mobile object by executing a second arithmetic process using the orientation of the mobile object calculated by executing the first calculation process and the orientation of the mobile object calculated by executing the second calculation process.

According to this aspect, the calculation device can calculate at least either of the position and the orientation of the mobile object by executing the following process when at least one of the first case, the second case, and the third case applies. In this case, the calculation device can calculate the position of the mobile object by executing the first arithmetic process using the position of the mobile object calculated by executing the first calculation process and the position of the mobile object calculated by executing the second calculation process. The calculation device can calculate the orientation of the mobile object by executing the second arithmetic process using the orientation of the mobile object calculated by executing the first calculation process and the orientation of the mobile object calculated by executing the second calculation process. With this configuration, the calculation device can further suppress the decrease in the accuracy of the position and orientation of the mobile object when at least one of the first case, the second case, and the third case applies.

(8) A second aspect of the present disclosure provides a calculation system. The calculation system includes:
one or more mobile objects movable by driverless operation;
a mobile object detection device configured to output three-dimensional point cloud data indicating the mobile object by a point cloud by detecting the mobile object from outside the mobile object;
an acquisition unit configured to acquire the three-dimensional point cloud data;
a calculation unit configured to calculate at least either of a position and an orientation of the mobile object using the three-dimensional point cloud data; and
at least one of (i) a prediction unit configured to predict that the three-dimensional point cloud data is expected to be defective, (ii) a detection unit configured to detect that the three-dimensional point cloud data is defective, and (iii) a determination unit configured to determine whether the mobile object is present in a specific area where the three-dimensional point cloud data is presumed in advance to be defective.

The calculation unit is configured to execute a first calculation process of calculating at least either of the position and the orientation of the mobile object by comparing the three-dimensional point cloud data with reference point cloud data prepared in advance, and a second calculation process of calculating at least either of the position and the orientation of the mobile object by applying graphic data having a predetermined shape to the three-dimensional point cloud data.

The calculation unit is configured to execute at least the second calculation process when at least one of a first case, a second case, and a third case applies. The first case is a case where the prediction unit predicts that the three-dimensional point cloud data is expected to be defective. The second case is a case where the detection unit detects that the three-dimensional point cloud data is defective. The third case is a case where the determination unit determines that the mobile object is present in the specific area.

According to this aspect, the calculation system can calculate at least either of the position and the orientation of the mobile object using the three-dimensional point cloud data. At this time, the calculation system can accurately calculate the position and orientation of the mobile object by comparing the three-dimensional point cloud data with the reference point cloud data through the first calculation process. When at least one of the first case, the second case, and the third case applies, the accuracy of the position and orientation of the mobile object calculated by the first calculation process may decrease. The calculation system can calculate at least either of the position and the orientation of the mobile object by executing at least the second calculation process when at least one of the first case, the second case, and the third case applies. With this configuration, when at least one of the first case, the second case, and the third case applies, the calculation system can estimate information corresponding to the defective portion of the point cloud constituting the three-dimensional point cloud data by applying the graphic data to the three-dimensional point cloud data through the second calculation process. Thus, the calculation system can suppress the decrease in the accuracy of the position and orientation of the mobile object when at least one of the first case, the second case, and the third case applies.

(9) A third aspect of the present disclosure provides a calculation method. The calculation method includes:
an acquisition step of acquiring three-dimensional point cloud data indicating, by a point cloud, a mobile object movable by driverless operation;
a calculation step of calculating at least either of a position and an orientation of the mobile object using the three-dimensional point cloud data; and
at least one of (i) a prediction step of predicting that the three-dimensional point cloud data is expected to be defective, (ii) a detection step of detecting that the three-dimensional point cloud data is defective, and (iii) a determination step of determining whether the mobile object is present in a specific area where the three-dimensional point cloud data is presumed in advance to be defective.

In the calculation step, a first calculation process is executable to calculate at least either of the position and the orientation of the mobile object by comparing the three-dimensional point cloud data with reference point cloud data prepared in advance, and a second calculation process is executable to calculate at least either of the position and the orientation of the mobile object by applying graphic data having a predetermined shape to the three-dimensional point cloud data.

In the calculation step, at least the second calculation process is executed when at least one of a first case, a second case, and a third case applies. The first case is a case where prediction is made in the prediction step that the three-dimensional point cloud data is expected to be defective. The second case is a case where detection is made in the detection step that the three-dimensional point cloud data is defective. The third case is a case where determination is made in the determination step that the mobile object is present in the specific area.

According to this aspect, at least either of the position and the orientation of the mobile object can be calculated using the three-dimensional point cloud data. At this time, the position and orientation of the mobile object can accurately be calculated by comparing the three-dimensional point cloud data with the reference point cloud data through the first calculation process. When at least one of the first case, the second case, and the third case applies, the accuracy of the position and orientation of the mobile object calculated by the first calculation process may decrease. According to this aspect, when at least one of the first case, the second case, and the third case applies, information corresponding to the defective portion of the point cloud constituting the three-dimensional point cloud data can be estimated by applying the graphic data to the three-dimensional point cloud data through execution of the second calculation process. Thus, it is possible to suppress the decrease in the accuracy of the position and orientation of the mobile object when at least one of the first case, the second case, and the third case applies.

(10) A fourth aspect of the present disclosure provides a calculation device. The calculation device includes:
an acquisition unit configured to acquire three-dimensional point cloud data indicating, by a point cloud, a mobile object movable by driverless operation;
a calculation unit configured to calculate at least either of a position and an orientation of the mobile object using the three-dimensional point cloud data, and output vehicle position information including at least either of the position and the orientation of the mobile object; and
a detection unit configured to detect that the three-dimensional point cloud data is defective. The calculation unit is configured to execute a first calculation process of calculating at least either of the position and the orientation of the mobile object by comparing the three-dimensional point cloud data with reference point cloud data prepared in advance, and a second calculation process of calculating at least either of the position and the orientation of the mobile object by applying graphic data having a predetermined shape to the three-dimensional point cloud data.

The calculation unit is configured to calculate at least either of the position and the orientation of the mobile object by executing the first calculation process and the second calculation process.

The detection unit is configured to detect that the three-dimensional point cloud data is defective using a first calculation result of at least either of the position and the orientation of the mobile object calculated by executing the first calculation process and a second calculation result of at least either of the position and the orientation of the mobile object calculated by executing the second calculation process.

The calculation unit is configured to, when the detection unit detects that the three-dimensional point cloud data is defective, select either of the first calculation result and the second calculation result as the vehicle position information to be output, and output the selected first calculation result or the selected second calculation result as the vehicle position information.

According to this aspect, the calculation device can detect, using the first calculation result and the second calculation result, that the three-dimensional point cloud data is defective. When the calculation device detects that the three-dimensional point cloud data is defective, the calculation device can select either of the first calculation result and the second calculation result as the vehicle position information to be output. That is, when the calculation device detects that the three-dimensional point cloud data is defective, the calculation device can make selection by determining which of the first calculation result and the second calculation result is more accurate. The calculation device can output the selected calculation result as the vehicle position information. With this configuration, the calculation device can suppress the decrease in the accuracy of the position and orientation of the mobile object when the calculation device detects that the three-dimensional point cloud data is defective.

(11) In the above aspect,
the acquisition unit may be configured to acquire a plurality of pieces of the three-dimensional point cloud data detected at different timings for the same mobile object.

The calculation unit may be configured to calculate at least either of the positions and the orientations of the mobile object at the different timings by executing the first calculation process and the second calculation process on the pieces of the three-dimensional point cloud data.

The calculation unit may be configured to generate first time series data on at least either of the positions and the orientations of the mobile object by arranging a plurality of the first calculation results at the different timings in chronological order.

The calculation unit may be configured to generate second time series data on at least either of the positions and the orientations of the mobile object by arranging a plurality of the second calculation results at the different timings in chronological order.

The detection unit may be configured to detect, using the first time series data and the second time series data, that at least one of the pieces of the three-dimensional point cloud data is defective.

The calculation unit may be configured to, when the detection unit detects that at least one of the pieces of the three-dimensional point cloud data is defective, use the first time series data and the second time series data to select, as the vehicle position information to be output, either of the first calculation result and the second calculation result calculated by executing the first calculation process and the second calculation process, respectively.

According to this aspect, the calculation device can acquire a plurality of pieces of the three-dimensional point cloud data detected at different timings for the same mobile object. The calculation device can generate the first time series data by executing the first calculation process on the acquired pieces of the three-dimensional point cloud data and arranging the first calculation results at the different timings in chronological order. The calculation device can generate the second time series data by executing the second calculation process on the acquired pieces of the three-dimensional point cloud data and arranging the second calculation results at the different timings in chronological order. The calculation device can detect, using the first time series data and the second time series data, that the three-dimensional point cloud data is defective. When the calculation device detects that the three-dimensional point cloud data is defective, using the first time series data and the second time series data, the calculation device can select, as the vehicle position information to be output, either of the first calculation result and the second calculation result calculated by executing the first calculation process and the second calculation process, respectively. That is, when the calculation device detects that at least one of the pieces of the three-dimensional point cloud data is defective, the calculation device can make selection by determining which of the first calculation result and the second calculation result is more accurate using the first time series data and the second time series data. The calculation device can output the selected calculation result as the vehicle position information. With this configuration, the calculation device can suppress the decrease in the accuracy of the position and orientation of the mobile object when the calculation device detects that at least one of the pieces of the three-dimensional point cloud data is defective.

(12) A fifth aspect of the present disclosure provides a calculation system. The calculation system includes:
one or more mobile objects movable by driverless operation;
a mobile object detection device configured to output three-dimensional point cloud data indicating the mobile object by a point cloud by detecting the mobile object from outside the mobile object;
an acquisition unit configured to acquire the three-dimensional point cloud data;
a calculation unit configured to calculate at least either of a position and an orientation of the mobile object using the three-dimensional point cloud data, and output vehicle position information including at least either of the position and the orientation of the mobile object; and
a detection unit configured to detect that the three-dimensional point cloud data is defective. The calculation unit is configured to execute a first calculation process of calculating at least either of the position and the orientation of the mobile object by comparing the three-dimensional point cloud data with reference point cloud data prepared in advance, and a second calculation process of calculating at least either of the position and the orientation of the mobile object by applying graphic data having a predetermined shape to the three-dimensional point cloud data.

The calculation unit is configured to calculate at least either of the position and the orientation of the mobile object by executing the first calculation process and the second calculation process.

The detection unit is configured to detect that the three-dimensional point cloud data is defective using a first calculation result of at least either of the position and the orientation of the mobile object calculated by executing the first calculation process and a second calculation result of at least either of the position and the orientation of the mobile object calculated by executing the second calculation process.

The calculation unit is configured to, when the detection unit detects that the three-dimensional point cloud data is defective, select either of the first calculation result and the second calculation result as the vehicle position information to be output, and output the selected first calculation result or the selected second calculation result as the vehicle position information.

According to this aspect, the calculation system can detect, using the first calculation result and the second calculation result, that the three-dimensional point cloud data is defective. When the calculation system detects that the three-dimensional point cloud data is defective, the calculation system can select either of the first calculation result and the second calculation result as the vehicle position information to be output. That is, when the calculation system detects that the three-dimensional point cloud data is defective, the calculation system can make selection by determining which of the first calculation result and the second calculation result is more accurate. The calculation system can output the selected calculation result as the vehicle position information. With this configuration, the calculation system can suppress the decrease in the accuracy of the position and orientation of the mobile object when the calculation system detects that the three-dimensional point cloud data is defective.

(13) A sixth aspect of the present disclosure provides a calculation method. The calculation method includes:
an acquisition step of acquiring three-dimensional point cloud data indicating, by a point cloud, a mobile object movable by driverless operation;
a first calculation step of calculating at least either of a position and an orientation of the mobile object using the three-dimensional point cloud data;
a detection step of detecting that the three-dimensional point cloud data is defective; and a second calculation step of outputting vehicle position information including at least either of the position and the orientation of the mobile object.

In the first calculation step and the second calculation step, a first calculation process is executable to calculate at least either of the position and the orientation of the mobile object by comparing the three-dimensional point cloud data with reference point cloud data prepared in advance, and a second calculation process is executable to calculate at least either of the position and the orientation of the mobile object by applying graphic data having a predetermined shape to the three-dimensional point cloud data.

In the first calculation step, at least either of the position and the orientation of the mobile object is calculated by executing the first calculation process and the second calculation process.

In the detection step, detection is made that the three-dimensional point cloud data is defective using a first calculation result of at least either of the position and the orientation of the mobile object calculated by executing the first calculation process and a second calculation result of at least either of the position and the orientation of the mobile object calculated by executing the second calculation process.

When detection is made in the detection step that the three-dimensional point cloud data is defective, in the second calculation step, either of the first calculation result and the second calculation result is selected as the vehicle position information to be output, and the selected first calculation result or the selected second calculation result is output as the vehicle position information.

According to this aspect, detection can be made, using the first calculation result and the second calculation result, that the three-dimensional point cloud data is defective. When detection is made that the three-dimensional point cloud data is defective, either of the first calculation result and the second calculation result calculated by executing the first calculation process and the second calculation process, respectively, can be selected as the vehicle position information to be output. That is, when detection is made that the three-dimensional point cloud data is defective, selection can be made by determining which of the first calculation result and the second calculation result is more accurate. Thus, the selected calculation result can be output as the vehicle position information. With this configuration, it is possible to suppress the decrease in the accuracy of the position and orientation of the mobile object when detection is made that the three-dimensional point cloud data is defective.

The present disclosure can be implemented in various forms other than the calculation device, the calculation system, and the calculation method. For example, the present disclosure can be implemented in the form of a method for manufacturing a calculation device, a calculation system, or a mobile object,, a method for controlling a calculation device, a calculation system, or a mobile object, a computer program for implementing the control method, and a non-transitory recording medium on which the computer program is recorded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing the configuration of a traveling system according to a first embodiment;

FIG. 2 is a block diagram showing the configuration of the traveling system according to the first embodiment;

FIG. 3 illustrates a second calculation process;

FIG. 4 is a flowchart showing a processing procedure of vehicle traveling control according to the first embodiment;

FIG. 5 is a flowchart showing a processing procedure according to the first embodiment;

FIG. 6 is a block diagram showing the configuration of a traveling system according to a second embodiment;

FIG. 7 is a flowchart showing a processing procedure according to the second embodiment;

FIG. 8 is a block diagram showing the configuration of a traveling system according to a third embodiment;

FIG. 9 is a flowchart showing a processing procedure according to the third embodiment;

FIG. 10 is a block diagram showing the configuration of a traveling system according to a fourth embodiment;

FIG. 11 is a flowchart showing a processing procedure according to the fourth embodiment;

FIG. 12 is a block diagram showing the configuration of a traveling system according to a fifth embodiment;

FIG. 13 is a flowchart showing a processing procedure according to the fifth embodiment;

FIG. 14 is a block diagram showing the configuration of a traveling system according to a sixth embodiment; and

FIG. 15 is a flowchart showing a processing procedure of vehicle traveling control according to the sixth embodiment.

### DETAILED DESCRIPTION OF EMBODIMENTS

### A. First Embodiment

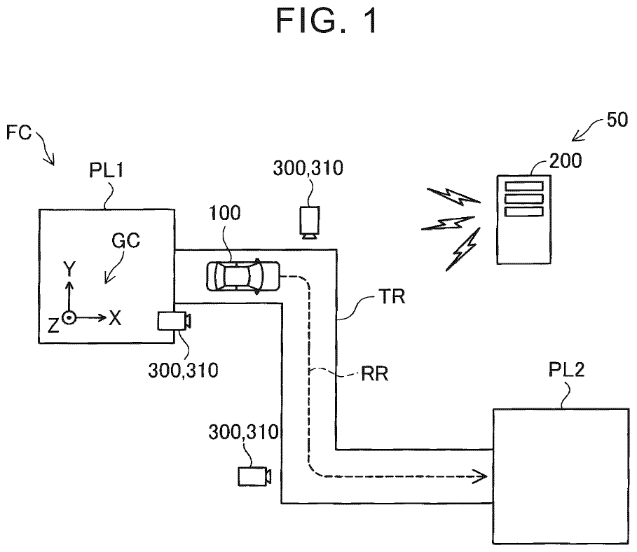

FIG. 1 is a conceptual diagram showing the configuration of a traveling system 50 according to a first embodiment. The traveling system 50 is a system for moving a mobile object without a traveling operation by an occupant on the mobile object. The traveling system 50 includes a calculation system 7 and a remote control device 80.

The calculation system 7 is a system for calculating at least either of the position and the orientation of a vehicle 100. The calculation system 7 includes one or more vehicles 100 as the mobile object, a calculation device 70, and one or more vehicle detection devices. In the present embodiment, the functions of the calculation device 70 and the remote control device 80 are implemented by a server 200.

The vehicle detection device detects the vehicle 100 from outside the vehicle 100 and outputs, as a detection result, three-dimensional point cloud data indicating the vehicle 100 by a point cloud. In the present embodiment, the vehicle detection device is a light detection and ranging sensor (LiDAR) serving as an external sensor 300. The external sensor 300 is positioned outside the vehicle 100. The external sensor 300 includes a communication device (not shown) and can communicate with other devices such as the server 200 by wired or wireless communication. The LiDAR is an example of a ranging device. In other embodiments, the vehicle detection device may be another sensor such as a stereo camera. The LiDAR serving as the external sensor 300 will hereinafter be referred to as “external LiDAR 310”.

In the present disclosure, the term “mobile object” means an object that is movable and may be, for example, a vehicle or an electric vertical take-off and landing aircraft (so-called flying vehicle). The vehicle may be a vehicle that travels on wheels or a vehicle that travels on endless tracks, and may be, for example, a passenger car, a truck, a bus, a two-wheeled vehicle, a four-wheeled vehicle, a tank, or a construction vehicle. The vehicle includes a battery electric vehicle (BEV), a gasoline vehicle, a hybrid vehicle, and a fuel cell electric vehicle. In a case where the mobile object is not a vehicle, the terms “vehicle” and “car” in the present disclosure can be replaced with “mobile object” as appropriate, and the term “travel” can be replaced with “move” as appropriate.

The vehicle 100 can travel by driverless operation. The term “driverless operation” means driving that is not based on a traveling operation by an occupant. The traveling operation means an operation related to at least one of “running”, “turning”, and “stopping” of the vehicle 100. The driverless operation is achieved by automatic or manual remote control using a device positioned outside the vehicle 100 or by autonomous control on the vehicle 100. An occupant who does not perform the traveling operation may be on the vehicle 100 that travels by driverless operation. Examples of the occupant who does not perform the traveling operation include a person simply sitting on a seat of the vehicle 100 and a person who performs work different from the traveling operation, such as assembling, inspection, or operation on switches, while being on the vehicle 100. Driving that is based on the traveling operation by an occupant may be referred to as “attended driving”.

The term “remote control” herein includes “full remote control” in which all of the operations of the vehicle 100 are fully determined from outside the vehicle 100, and “partial remote control” in which part of the operations of the vehicle 100 is determined from outside the vehicle 100. The term “autonomous control” includes “fully autonomous control” in which the vehicle 100 autonomously controls its operations without receiving any information from devices outside the vehicle 100, and “partially autonomous control” in which the vehicle 100 autonomously controls its operations using information received from devices outside the vehicle 100.

In the present embodiment, the traveling system 50 is used in a factory FC where the vehicle 100 is manufactured. The reference coordinate system of the factory FC is a global coordinate system GC, and any position in the factory FC can be represented by X, Y, and Z coordinates in the global coordinate system GC. The factory FC includes a first place PL1 and a second place PL2. The first place PL1 and the second place PL2 are connected by a traveling road TR where the vehicle 100 can travel. In the factory FC, a plurality of external sensors 300 is installed along the traveling road TR. The positions of the external sensors 300 in the factory FC are adjusted in advance. The vehicle 100 moves from the first place PL1 to the second place PL2 along the traveling road TR by driverless operation.

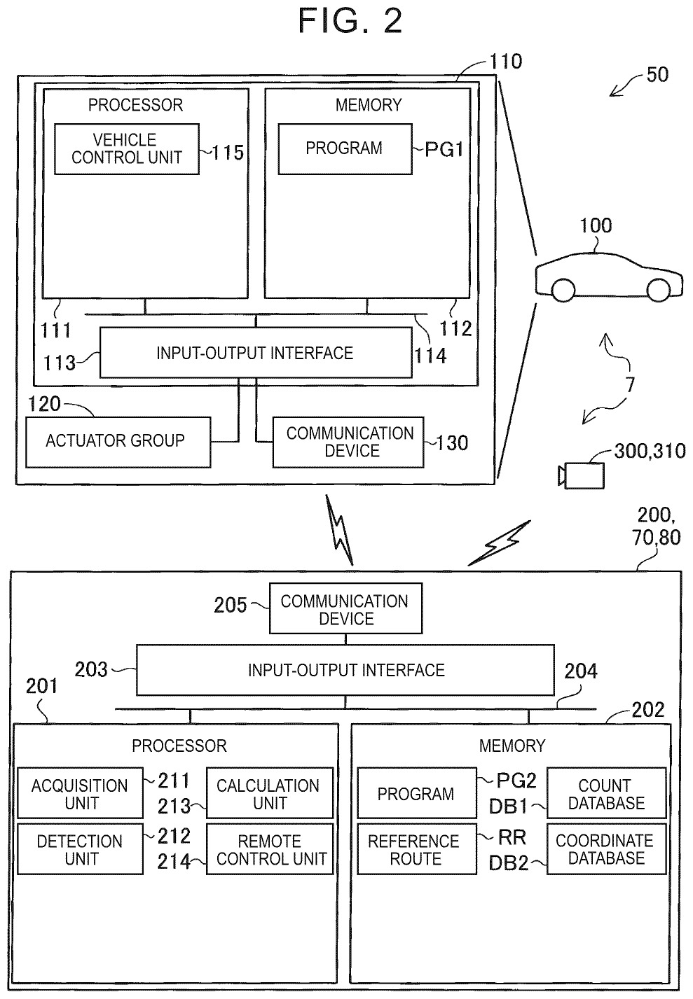

FIG. 2 is a block diagram showing the configuration of the traveling system 50 according to the first embodiment. The vehicle 100 includes a vehicle control device 110 that controls each part of the vehicle 100, an actuator group 120 including one or more actuators that are driven under the control of the vehicle control device 110, and a communication device 130 that communicates with external devices such as the server 200 by wireless communication. The actuator group 120 includes an actuator of a drive device that accelerates the vehicle 100, an actuator of a steering device that changes the traveling direction of the vehicle 100, and an actuator of a braking device that decelerates the vehicle 100.

The vehicle control device 110 is a computer including a processor 111, a memory 112, an input-output interface 113, and an internal bus 114. The processor 111, the memory 112, and the input-output interface 113 are connected to be bidirectionally communicable via the internal bus 114. The actuator group 120 and the communication device 130 are connected to the input-output interface 113. The processor 111 implements various functions including functions of a vehicle control unit 115 by executing a program PG1 stored in the memory 112.

The vehicle control unit 115 causes the vehicle 100 to travel by controlling the actuator group 120. The vehicle control unit 115 can cause the vehicle 100 to travel by controlling the actuator group 120 using a traveling control signal received from the server 200. The traveling control signal is a control signal for causing the vehicle 100 to travel. In the present embodiment, the traveling control signal includes an acceleration and a steering angle of the vehicle 100 as parameters. In other embodiments, the traveling control signal may include a speed of the vehicle 100 as a parameter instead of or in addition to the acceleration of the vehicle 100.

The server 200 is a computer including a processor 201, a memory 202, an input-output interface 203, and an internal bus 204. The processor 201, the memory 202, and the input-output interface 203 are connected to be bidirectionally communicable via the internal bus 204. A communication device 205 that communicates with various devices outside the server 200 is connected to the input-output interface 203. The communication device 205 can communicate with the vehicle 100 by wireless communication, and can communicate with each external sensor 300 by wired or wireless communication. The processor 201 implements the following functions by executing a program PG2 stored in the memory 202. The processor 201 implements various functions including functions of an acquisition unit 211, a detection unit 212, a calculation unit 213, and a remote control unit 214.

The acquisition unit 211 acquires three-dimensional point cloud data obtained by detecting the vehicle 100 from the outside using the external LiDAR 310.

The detection unit 212 is one of the functional units that acquires information on a defect in three-dimensional point cloud data.

The detection unit 212 detects that the three-dimensional point cloud data acquired by the acquisition unit 211 is defective.

For example, the detection unit 212 detects that the three-dimensional point cloud data is defective when an actual count is smaller than a predetermined reference count. The actual count is the count of points constituting the three-dimensional point cloud data actually acquired by the acquisition unit 211. The reference count is a threshold for detecting that the three-dimensional point cloud data is defective. The reference count is set, for example, using a planned count. The planned count is the count of points planned to be acquired as three-dimensional point cloud data when the acquisition unit 211 acquires the three-dimensional point cloud data. The reference count is set, for example, by multiplying the planned count by a predetermined multiplication factor. The multiplication factor is a number smaller than one. The multiplication factor is determined, for example, based on the degree of influence on the control on the vehicle 100. The degree of influence on the control on the vehicle 100 is determined, for example, based on the correlation between a defect ratio of the three-dimensional point cloud data and the accuracy of the position and orientation of the vehicle 100 calculated using the three-dimensional point cloud data. The defect ratio is the ratio of the count of points corresponding to a defective portion to the total count of points constituting the three-dimensional point cloud data. That is, the reference count serving as a reference for detecting a defect in three-dimensional point cloud data is set based on whether the accuracy of the position and orientation of the vehicle 100 calculated using the partially defective three-dimensional point cloud data is within a permissible range. For example, when the planned count is 500, the reference count may be 300.

The reference count is, for example, preset for each predetermined detection area within a detection range of each external LiDAR 310. In this case, the detection unit 212 detects that the three-dimensional point cloud data is defective by executing, for example, the following process. Specifically, the detection unit 212 first uses determination information to identify a detection area including the vehicle 100 among a plurality of detection areas of a plurality of external LiDARs 310. The determination information includes, for example, a transmission history of the traveling control signal, the position and orientation of the vehicle 100 at a timing prior to the detection timing, and a traveling speed of the vehicle 100. Next, the detection unit 212 uses a count database DB1 prestored in the memory 202 of the server 200 to acquire a reference count of the detection area identified as the area including the detection target vehicle 100. The count database DB1 is a database in which reference counts are associated with the detection areas of the external LiDARs 310. Next, the detection unit 212 compares the actual count with the reference count and detects that the three-dimensional point cloud data is defective when the actual count is smaller than the reference count.

The detection unit 212 may detect that the three-dimensional point cloud data is defective by another method. The detection unit 212 may detect that the three-dimensional point cloud data is defective, for example, when an object that may be an obstacle is detected between the vehicle 100 and the external LiDAR 310. The object that may be an obstacle may be a moving object or a stationary object. The moving object is an object that may approach the detection target vehicle 100 by moving. Examples of the moving object include a creature such as a human or an animal, a vehicle 100 different from the detection target vehicle 100, and a manually or automatically movable manufacturing device such as an automated guided vehicle (AGV). The stationary object is an object that is placed naturally or artificially on the traveling road TR where the vehicle 100 travels. Examples of the stationary object include a manufacturing device having a working layout changeable as appropriate, equipment such as a road cone and a signboard placed on the traveling road TR, a flying object such as a fallen leaf that flies onto the traveling road TR, and a plant such as a tree having a size changeable by growth etc.

The calculation unit 213 uses three-dimensional point cloud data to calculate at least either of the position and the orientation of the vehicle 100, and outputs vehicle position information. In the present embodiment, the position of the vehicle 100 is a position of a positioning point preset at a specific part of the vehicle 100. The orientation of the vehicle 100 is a direction indicated by a vector extending from the rear side to the front side of the vehicle 100 along a longitudinal axis of the vehicle 100. The vehicle position information serves as a basis for generating the traveling control signal. In the present embodiment, the vehicle position information includes the position and orientation of the vehicle 100 in the global coordinate system GC of the factory FC. The calculation unit 213 can execute a first calculation process and a second calculation process.

The first calculation process is a process of calculating at least either of the position and the orientation of the vehicle 100 by comparing the three-dimensional point cloud data acquired by the acquisition unit 211 with reference point cloud data prepared in advance. In the first calculation process of the present embodiment, the calculation unit 213 calculates the position and orientation of the vehicle 100 indicated by the three-dimensional point cloud data by matching the three-dimensional point cloud data with the reference point cloud data. The reference point cloud data is point cloud data that virtually reproduces the vehicle 100. Examples of the reference point cloud data include three-dimensional computer-aided design (CAD) data indicating the vehicle 100. An algorithm such as iterative closest point (ICP) and normal distribution transform (NDT) is used to match the three-dimensional point cloud data with the reference point cloud data.

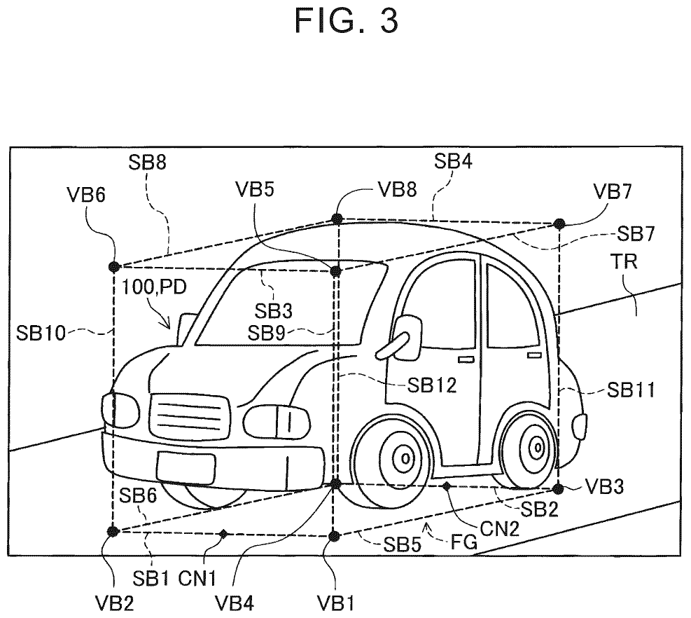

FIG. 3 illustrates the second calculation process. The second calculation process is a process of calculating at least either of the position and the orientation of the vehicle 100 by applying graphic data FG having a predetermined shape to three-dimensional point cloud data PD acquired by the acquisition unit 211. The shape of the graphic data FG is a shape with which the external shape of the vehicle 100 can be estimated when the graphic data FG is applied to surround the three-dimensional point cloud data PD. Examples of the shape of the graphic data FG include a rectangular parallelepiped shape. In this case, the graphic data FG is also referred to as “bounding box”. When the shape of the graphic data FG is the rectangular parallelepiped shape, for example, the ratio of first sides SB1 to SB4, second sides SB5 to SB8, and third sides SB9 to SB12 orthogonal to each other corresponds to the ratio of the width, the overall length, and the height. In other embodiments, the shape of the graphic data FG may be a shape other than the rectangular parallelepiped shape. Examples of the shape of the graphic data FG include a rectangular shape.

In the second calculation process of the present embodiment, the calculation unit 213 calculates the position and orientation of the vehicle 100 indicated by the three-dimensional point cloud data PD by applying the rectangular parallelepiped graphic data FG to surround the three-dimensional point cloud data PD. Specifically, the calculation unit 213 first applies the rectangular parallelepiped graphic data FG to surround the three-dimensional point cloud data PD. Next, the calculation unit 213 executes the following process to calculate the position of the vehicle 100. The calculation unit 213 acquires the coordinates of eight vertices VB1 to VB8 of the rectangular parallelepiped shape constituting the graphic data FG. Each set of coordinates of the graphic data FG is associated with additional information indicating a corresponding one of the eight vertices VB1 to VB8 of the rectangular parallelepiped shape constituting the graphic data FG. Next, the calculation unit 213 uses a coordinate database DB2 stored in the memory 202 of the server 200 to calculate the coordinates of the positioning point of the vehicle 100 as the position of the vehicle 100 based on the coordinates of the eight vertices VB1 to VB8 of the rectangular parallelepiped shape constituting the graphic data FG. The coordinate database DB2 indicates the relative positional relationship between the eight vertices VB1 to VB8 of the rectangular parallelepiped shape constituting the graphic data FG and the positioning point of the vehicle 100. The calculation unit 213 executes the following process to calculate the orientation of the vehicle 100. The calculation unit 213 calculates the orientation of the vehicle 100 using the coordinates of a first central position CN1 and the coordinates of a second central position CN2. The first central position CN1 is the central position of the side SB1 extending along the vehicle width direction on the front side of the vehicle 100 out of the 12 sides SB1 to SB 12 of the rectangular parallelepiped shape constituting the graphic data FG. The second central position CN2 is the central position of the side SB2 extending along the vehicle width direction on the rear side of the vehicle 100 out of the 12 sides SB1 to SB 12 of the rectangular parallelepiped shape constituting the graphic data FG.

When the detection unit 212 detects that the three-dimensional point cloud data PD is defective, the calculation unit 213 calculates the position and orientation of the vehicle 100 by executing at least the second calculation process. In the present embodiment, when the detection unit 212 detects that the three-dimensional point cloud data PD is defective, the calculation unit 213 executes the first calculation process and the second calculation process. The calculation unit 213 executes an arithmetic process to take an arithmetic mean of first coordinates indicating the position of the vehicle 100 calculated by executing the first calculation process and second coordinates indicating the position of the vehicle 100 calculated by executing the second calculation process. The calculation unit 213 executes an arithmetic process to take an arithmetic mean of a first vector indicating the orientation of the vehicle 100 calculated by executing the first calculation process and a second vector indicating the orientation of the vehicle 100 calculated by executing the second calculation process. The calculation unit 213 outputs vehicle position information indicating that the coordinates obtained by taking the arithmetic mean of the first coordinates and the second coordinates are the position of the vehicle 100 and the vector obtained by taking the arithmetic mean of the first vector and the second vector is the orientation of the vehicle 100.

The calculation unit 213 may output vehicle position information indicating that coordinates obtained by taking a weighted average of the first coordinates and the second coordinates are the position of the vehicle 100 and a vector obtained by taking a weighted average of the first vector and the second vector is the orientation of the vehicle 100. In this case, in an arithmetic process to take the weighted average of the first coordinates and the second coordinates, the second coordinates are weighted based on the defect ratio of the three-dimensional point cloud data PD, for example, so that the weight increases as the defect ratio of the three-dimensional point cloud data PD increases. In an arithmetic process to take the weighted average of the first vector and the second vector, the second vector is weighted based on the defect ratio of the three-dimensional point cloud data PD, for example, so that the weight increases as the defect ratio of the three-dimensional point cloud data PD increases.

When the detection unit 212 does not detect that the three-dimensional point cloud data PD is defective, the calculation unit 213 executes the first calculation process without executing the second calculation process. Thus, the calculation unit 213 outputs vehicle position information indicating that the first coordinates calculated by executing the first calculation process are the position of the vehicle 100 and the first vector calculated by executing the first calculation process is the orientation of the vehicle 100.

The remote control unit 214 acquires detection results from the sensors, generates a traveling control signal for controlling the actuator group 120 of the vehicle 100 using the detection results, and transmits the traveling control signal to the vehicle 100, thereby causing the vehicle 100 to travel by remote control. The remote control unit 214 may generate and output not only the traveling control signal but also control signals for controlling, for example, various auxiliary devices provided in the vehicle 100 and actuators that operate various types of equipment such as wipers, power windows, and lamps. That is, the remote control unit 214 may operate the various types of equipment and the various auxiliary devices by remote control.

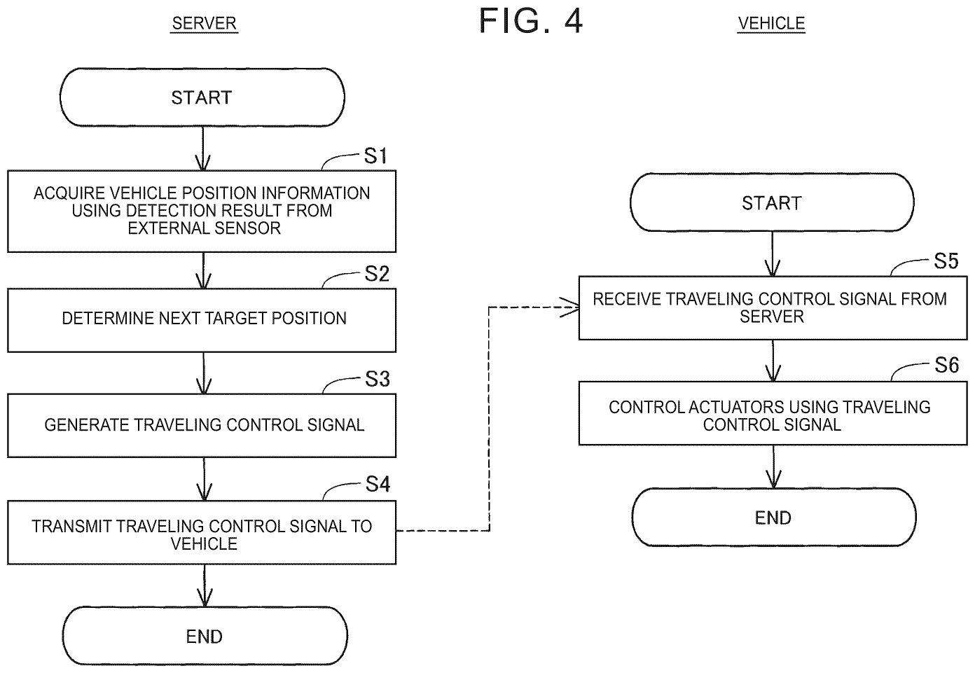

FIG. 4 is a flowchart showing a processing procedure of the traveling control on the vehicle 100 according to the first embodiment. The flow shown in FIG. 4 is repeated at predetermined time intervals, for example, during a period in which the vehicle 100 is traveling under the remote control of the server 200. In the processing procedure of FIG. 4, the processor 201 of the server 200 executes the program PG2 to function as the acquisition unit 211, the detection unit 212, the calculation unit 213, and the remote control unit 214. The processor 111 of the vehicle 100 executes the program PG1 to function as the vehicle control unit 115.

In step S1, the processor 201 of the server 200 acquires vehicle position information using a detection result output from the external sensor 300. Specifically, in step S1, the processor 201 acquires the vehicle position information using the three-dimensional point cloud data PD acquired from the external LiDAR 310 that is the external sensor 300.

In step S2, the processor 201 of the server 200 determines a target position to which the vehicle 100 is expected to move next. In the present embodiment, the target position is represented by X, Y, and Z coordinates in the global coordinate system GC. The memory 202 of the server 200 prestores a reference route RR along which the vehicle 100 is expected to travel. The route is represented by a node indicating a departure point, nodes indicating passing points, a node indicating a destination, and links connecting the nodes. The processor 201 uses the vehicle position information and the reference route RR to determine the target position to which the vehicle 100 is expected to move next. The processor 201 determines the target position on the reference route RR ahead of the current position of the vehicle 100.

In step S3, the processor 201 of the server 200 generates a traveling control signal for causing the vehicle 100 to travel toward the determined target position. The processor 201 calculates a traveling speed of the vehicle 100 based on transition in the position of the vehicle 100, and compares the calculated traveling speed with a target speed. The processor 201 generally determines an acceleration so that the vehicle 100 accelerates when the traveling speed is lower than the target speed, and determines an acceleration so that the vehicle 100 decelerates when the traveling speed is higher than the target speed. When the vehicle 100 is located on the reference route RR, the processor 201 determines a steering angle and an acceleration so that the vehicle 100 does not deviate from the reference route RR. When the vehicle 100 is not located on the reference route RR, in other words, when the vehicle 100 deviates from the reference route RR, the processor 201 determines a steering angle and an acceleration so that the vehicle 100 returns to the reference route RR.

In step S4, the processor 201 of the server 200 transmits the generated traveling control signal to the vehicle 100. The processor 201 repeats, at a predetermined cycle, the acquisition of the vehicle position information, the determination of the target position, the generation of the traveling control signal, and the transmission of the traveling control signal.

In step S5, the processor 111 of the vehicle 100 receives the traveling control signal transmitted from the server 200. In step S6, the processor 111 of the vehicle 100 controls the actuator group 120 using the received traveling control signal to cause the vehicle 100 to travel at the acceleration and the steering angle indicated by the traveling control signal. The processor 111 repeats, at a predetermined cycle, the reception of the traveling control signal and the control on the actuator group 120. With the system 50 according to the present embodiment, the vehicle 100 can be caused to travel by remote control, and the vehicle 100 can be moved without using transport equipment such as a crane or a conveyor.

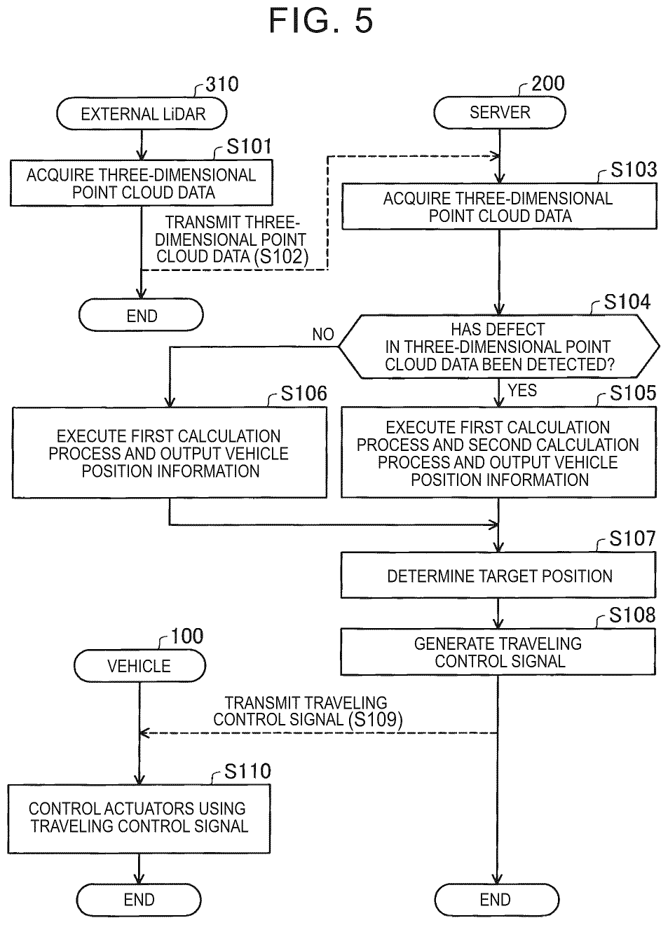

FIG. 5 is a flowchart showing a processing procedure according to the first embodiment. The flow shown in FIG. 5 is repeated at predetermined time intervals, for example, during a period in which the vehicle 100 is traveling under the remote control of the server 200.

In step S101, the external LiDAR 310 acquires three-dimensional point cloud data PD. In step S102, the external LiDAR 310 transmits the three-dimensional point cloud data PD to the server 200.

In step S103, the acquisition unit 211 of the server 200 acquires the three-dimensional point cloud data PD. In step S104, the detection unit 212 detects whether the three-dimensional point cloud data PD acquired by the acquisition unit 211 is defective.

When the detection unit 212 detects that the three-dimensional point cloud data PD is defective (step S104: Yes), the calculation unit 213 executes the first calculation process and the second calculation process in step S105. The calculation unit 213 outputs vehicle position information indicating that coordinates calculated by executing a predetermined arithmetic process on the first coordinates and the second coordinates are the position of the vehicle 100 and a vector calculated by executing a predetermined arithmetic process on the first vector and the second vector is the orientation of the vehicle 100. When the detection unit 212 does not detect that the three-dimensional point cloud data PD is defective (step S104: No), the calculation unit 213 executes the first calculation process without executing the second calculation process in step S106 to calculate the position and orientation of the vehicle 100, and outputs vehicle position information. In step S107, the remote control unit 214 uses the vehicle position information and the reference route RR to determine a target position to which the vehicle 100 is expected to move next. In step S108, the remote control unit 214 generates a traveling control signal for causing the vehicle 100 to travel toward the determined target position. In step S109, the remote control unit 214 transmits the generated traveling control signal to the vehicle 100.

In step S110, the vehicle control unit 115 of the vehicle control device 110 controls the actuator group 120 using the received traveling control signal to cause the vehicle 100 to travel at an acceleration and a steering angle indicated by the traveling control signal.

According to the first embodiment, the calculation system 7 can calculate the position and orientation of the vehicle 100 using the three-dimensional point cloud data PD indicating the vehicle 100 and output from the external LiDAR 310 to cause the vehicle 100 to travel by remote control. At this time, the calculation system 7 can accurately calculate the position and orientation of the vehicle 100 by matching the three-dimensional point cloud data PD output from the external LiDAR 310 with the reference point cloud data prepared in advance through the first calculation process. If the three-dimensional point cloud data PD is defective, however, the accuracy of matching between the three-dimensional point cloud data PD and the reference point cloud data may decrease and the accuracy of the position and orientation of the vehicle 100 may decrease. According to the first embodiment, the calculation system 7 can detect that the acquired three-dimensional point cloud data PD is defective. When the calculation system 7 detects that the three-dimensional point cloud data PD is defective, the calculation system 7 can calculate the position and orientation of the vehicle 100 by executing at least the second calculation process. With this configuration, the calculation system 7 can achieve the following by applying the graphic data FG to the three-dimensional point cloud data PD through the second calculation process when the calculation system 7 detects that the three-dimensional point cloud data PD is defective. In this case, the calculation system 7 can estimate, based on the graphic data FG, the external shape of the vehicle 100 that was not acquirable due to the defect in the three-dimensional point cloud data PD, and can estimate the dimensions of the vehicle 100, such as the width, the overall length, and the height. Thus, the calculation system 7 can supplement information corresponding to the defective portion of the point cloud constituting the three-dimensional point cloud data PD. As described above, the calculation system 7 can suppress the decrease in the accuracy of the position and orientation of the vehicle 100 when the calculation system 7 detects that the three-dimensional point cloud data PD is defective.

According to the first embodiment, the calculation system 7 can detect that the three-dimensional point cloud data PD is defective when the count of points constituting the three-dimensional point cloud data PD is smaller than the predetermined count.

According to the first embodiment, the calculation system 7 can determine the threshold for detecting that the three-dimensional point cloud data PD is defective based on the degree of influence on the control on the vehicle 100.

According to the first embodiment, the calculation system 7 can detect that the three-dimensional point cloud data PD is defective when an object that may be an obstacle is detected between the vehicle 100 and the external LiDAR 310 in the three-dimensional point cloud data PD.

According to the first embodiment, the calculation system 7 can calculate the first coordinates and the first vector by executing the first calculation process when the calculation system 7 detects that the three-dimensional point cloud data PD is defective. Further, the calculation system 7 can calculate the second coordinates and the second vector by executing the second calculation process when the calculation system 7 detects that the three-dimensional point cloud data PD is defective. Thus, the calculation system 7 can output the vehicle position information indicating that the coordinates calculated by executing the predetermined arithmetic process on the first coordinates and the second coordinates are the position of the vehicle 100 and the vector calculated by executing the predetermined arithmetic process on the first vector and the second vector is the orientation of the vehicle 100.

According to the first embodiment, when the calculation system 7 detects that the three-dimensional point cloud data PD is defective, the calculation system 7 can output the vehicle position information indicating that the coordinates obtained by taking the arithmetic mean of the first coordinates and the second coordinates are the position of the vehicle 100 and the vector obtained by taking the arithmetic mean of the first vector and the second vector is the orientation of the vehicle 100.

According to the first embodiment, the calculation system 7 can execute the following process when the calculation system 7 detects that the three-dimensional point cloud data PD is defective. In this case, the calculation system 7 can output the vehicle position information indicating that the coordinates obtained by taking the weighted average of the first coordinates and the second coordinates so that the weight of the second coordinates is larger than that of the first coordinates are the position of the vehicle 100 and the vector obtained by taking the weighted average of the first vector and the second vector so that the weight of the second vector is larger than that of the first vector is the orientation of the vehicle 100. With this configuration, the decrease in the accuracy of the position and orientation of the vehicle 100 can further be suppressed. In this case, in the arithmetic process to take the weighted average of the first coordinates and the second coordinates, the second coordinates may be weighted based on the defect ratio of the three-dimensional point cloud data PD so that the weight increases as the defect ratio of the three-dimensional point cloud data PD increases. In the arithmetic process to take the weighted average of the first vector and the second vector, the second vector may be weighted based on the defect ratio of the three-dimensional point cloud data PD so that the weight increases as the defect ratio of the three-dimensional point cloud data PD increases. With this configuration, the decrease in the accuracy of the position and orientation of the vehicle 100 can further be suppressed.

The calculation system 7 only needs to calculate at least either of the position and the orientation of the vehicle 100, and may calculate the position of the vehicle 100 without calculating the orientation of the vehicle 100, or may calculate the orientation of the vehicle 100 without calculating the position of the vehicle 100. That is, the vehicle position information includes at least either of the position and the orientation of the vehicle 100.

### B. Second Embodiment

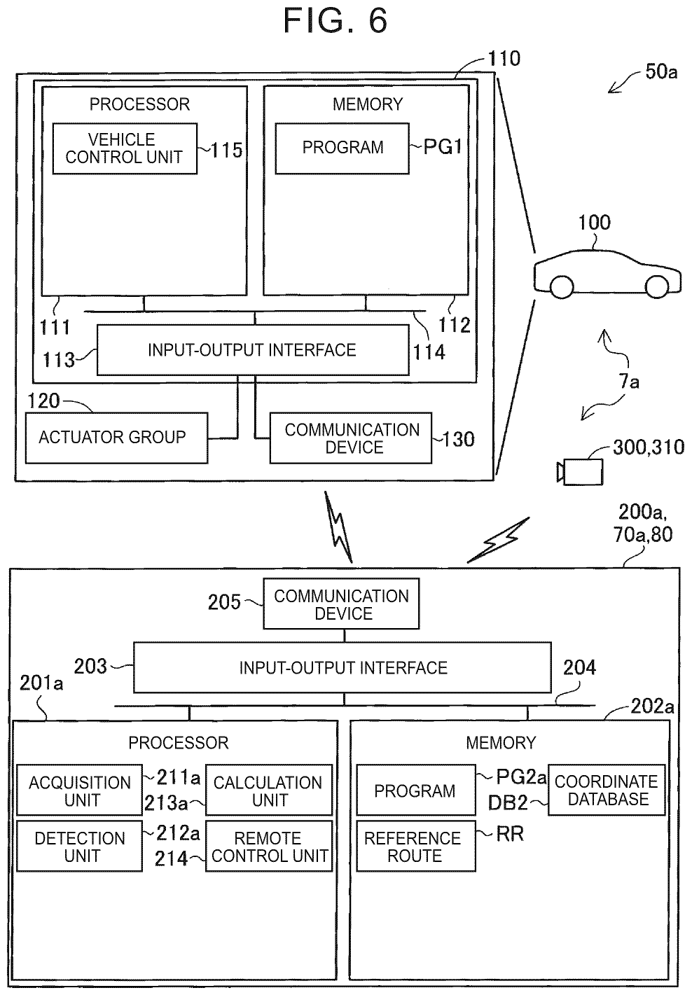

FIG. 6 is a block diagram showing the configuration of a traveling system 50a according to a second embodiment. The traveling system 50a includes a calculation system 7a and the remote control device 80. The calculation system 7a includes one or more vehicles 100, a calculation device 70a, and one or more external LiDARs 310. In the present embodiment, the functions of the calculation device 70a and the remote control device 80 are implemented by a server 200a. In the present embodiment, the calculation system 7a differs from the calculation system in the first embodiment in terms of the detection method for detecting that the three-dimensional point cloud data PD is defective and the calculation method for calculating the position and orientation of the vehicle 100. The other configuration of the traveling system 50a is similar to that in the first embodiment unless otherwise specified. The same components as those in the first embodiment are represented by the same reference signs and the description thereof will be omitted.

The server 200a is a computer including a processor 201a, a memory 202a, the input-output interface 203, and the internal bus 204. The processor 201a implements the following functions by executing a program PG2a stored in the memory 202a. The processor 201a implements various functions including functions of an acquisition unit 211a, a detection unit 212a, a calculation unit 213a, and the remote control unit 214.

The acquisition unit 211a acquires a plurality of pieces of three-dimensional point cloud data PD detected at different timings for the same vehicle 100.

The calculation unit 213a executes the first calculation process on the pieces of three-dimensional point cloud data PD acquired by the acquisition unit 211a to calculate the positions and orientations of the vehicle 100 at the different timings. The calculation unit 213a generates time series data on the positions of the vehicle 100 and time series data on the orientations of the vehicle 100 by arranging the positions and orientations of the vehicle 100 at the different timings in chronological order.

The detection unit 212a detects, using the pieces of time series data, that at least one of the pieces of three-dimensional point cloud data PD acquired by the acquisition unit 211a is defective. When the three-dimensional point cloud data PD is defective and the accuracy of matching between the three-dimensional point cloud data PD and the reference point cloud data decreases to cause a decrease in the accuracy of the position and orientation of the vehicle 100, variation may occur in the positions and orientations of the vehicle 100 at the individual timings in the pieces of time series data. In the present embodiment, the detection unit 212a detects that the three-dimensional point cloud data PD is defective when the variation in at least either of the positions and orientations at the individual timings in the pieces of time series data is equal to or larger than a predetermined variation threshold. The variation threshold is determined, for example, based on the degree of influence on the control on the vehicle 100.

When the detection unit 212a detects that at least one of the pieces of three-dimensional point cloud data PD is defective, the calculation unit 213a executes the second calculation process without executing the first calculation process. Thus, the calculation unit 213a outputs vehicle position information indicating that the second coordinates calculated by executing the second calculation process are the position of the vehicle 100 and the second vector calculated by executing the second calculation process is the orientation of the vehicle 100. When the detection unit 212a does not detect that the three-dimensional point cloud data PD is defective, the calculation unit 213a outputs vehicle position information indicating that the first coordinates calculated by executing the first calculation process are the position of the vehicle 100 and the first vector calculated by executing the first calculation process is the orientation of the vehicle 100.

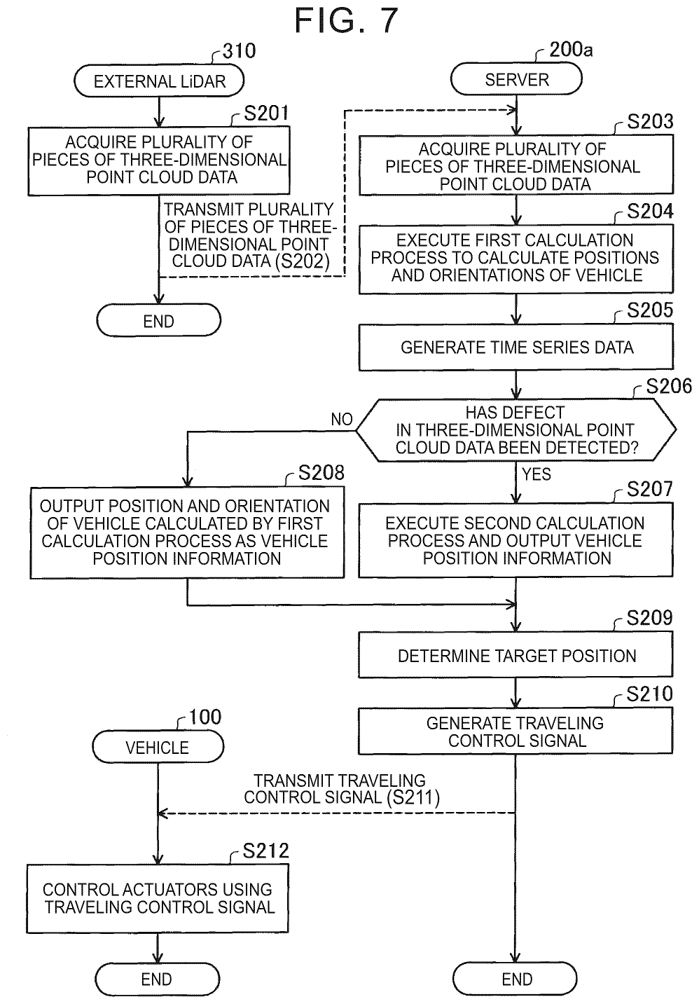

FIG. 7 is a flowchart showing a processing procedure according to the second embodiment. The flow shown in FIG. 7 is repeated at predetermined time intervals, for example, during a period in which the vehicle 100 is traveling under the remote control of the server 200a.

In step S201, the external LiDAR 310 detects the same vehicle 100 at a plurality of different timings. Thus, the external LiDAR 310 acquires a plurality of pieces of three-dimensional point cloud data PD detected at the different timings for the same vehicle 100. In step S202, the external LiDAR 310 transmits the pieces of three-dimensional point cloud data PD to the server 200a.

In step S203, the acquisition unit 211a of the server 200a acquires the pieces of three-dimensional point cloud data PD detected at the different timings for the same vehicle 100. In step S204, the calculation unit 213a executes the first calculation process on the pieces of three-dimensional point cloud data PD acquired by the acquisition unit 211a to calculate the positions and orientations of the vehicle 100 at the different timings. In step S205, the calculation unit 213a generates time series data on the positions of the vehicle 100 and time series data on the orientations of the vehicle 100 by arranging the positions and orientations of the vehicle 100 at the different timings in chronological order. In step S206, the detection unit 212a detects, using the pieces of time series data, whether at least one of the pieces of three-dimensional point cloud data PD acquired by the acquisition unit 211a is defective. When the detection unit 212a detects that at least one of the pieces of three-dimensional point cloud data PD is defective (step S206: Yes), the calculation unit 213a executes the second calculation process without executing the first calculation process in step S207 to calculate the position and orientation of the vehicle 100, and outputs vehicle position information. When the detection unit 212a does not detect that any of the pieces of three-dimensional point cloud data PD is defective (step S206: No), the calculation unit 213a outputs, as vehicle position information, the position and orientation of the vehicle 100 calculated by executing the first calculation process in step S208. In step S209, the remote control unit 214 uses the vehicle position information and the reference route RR to determine a target position to which the vehicle 100 is expected to move next. In step S210, the remote control unit 214 generates a traveling control signal for causing the vehicle 100 to travel toward the determined target position. In step S211, the remote control unit 214 transmits the generated traveling control signal to the vehicle 100.

In step S212, the vehicle control unit 115 of the vehicle control device 110 controls the actuator group 120 using the received traveling control signal to cause the vehicle 100 to travel at an acceleration and a steering angle indicated by the traveling control signal.

According to the second embodiment, the calculation system 7a can acquire a plurality of pieces of three-dimensional point cloud data PD detected at different timings for the same vehicle 100. The calculation system 7a can calculate the positions and orientations of the vehicle 100 at the different timings by executing the first calculation process on the acquired pieces of three-dimensional point cloud data PD. The calculation system 7a can generate the time series data on the positions of the vehicle 100 and the time series data on the orientations of the vehicle 100 by arranging the positions and orientations of the vehicle 100 at the different timings in chronological order. Thus, the calculation system 7a can detect, using the pieces of time series data, that at least one of the pieces of three-dimensional point cloud data PD is defective. When the calculation system 7a detects that at least one of the pieces of three-dimensional point cloud data PD is defective, the calculation system 7a can calculate the position and orientation of the vehicle 100 by executing the second calculation process without executing the first calculation process. With this configuration, the calculation system 7a can suppress the decrease in the accuracy of the position and orientation of the vehicle 100 when the three-dimensional point cloud data PD is defective.

According to the second embodiment, the calculation system 7a can detect that the three-dimensional point cloud data PD is defective when the variation in at least either of the positions and orientations at the individual timings in the pieces of time series data is equal to or larger than the predetermined threshold.

### C. Third Embodiment

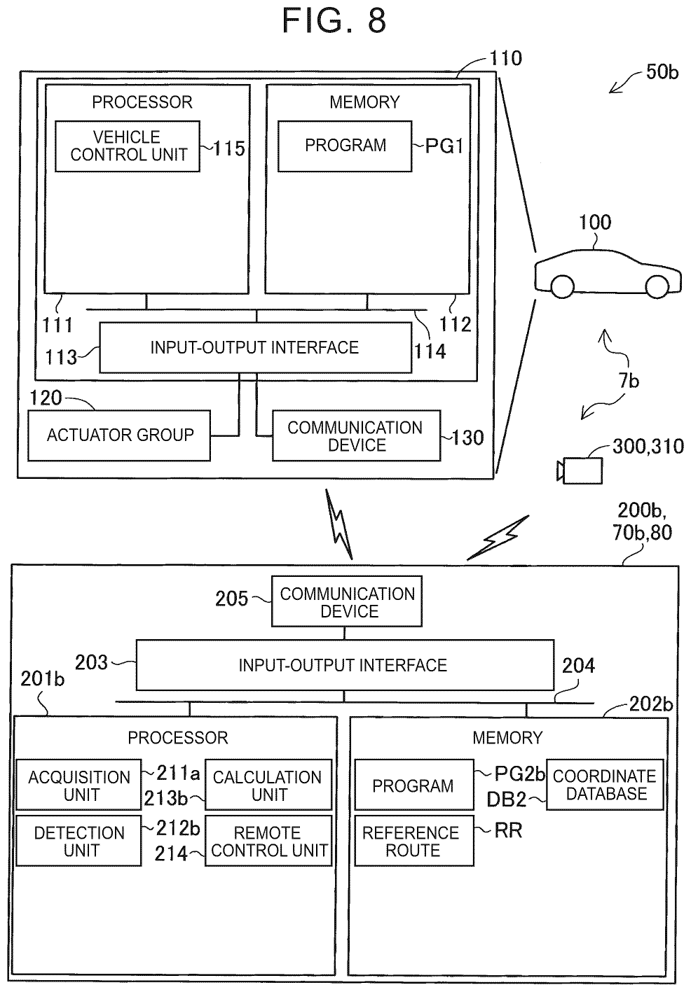

FIG. 8 is a block diagram showing the configuration of a traveling system 50b according to a third embodiment. The traveling system 50b includes a calculation system 7b and the remote control device 80. The calculation system 7b includes one or more vehicles 100, a calculation device 70b, and one or more external LiDARs 310. In the present embodiment, the functions of the calculation device 70b and the remote control device 80 are implemented by a server 200b. In the present embodiment, the calculation system 7b differs from the calculation system in the first embodiment in terms of the detection method for detecting that the three-dimensional point cloud data PD is defective and the calculation method for calculating the position and orientation of the vehicle 100. The other configuration of the traveling system 50b is similar to that in the first embodiment unless otherwise specified. The same components as those in each of the above embodiments are represented by the same reference signs and the description thereof will be omitted.

The server 200b is a computer including a processor 201b, a memory 202b, the input-output interface 203, and the internal bus 204. The processor 201b implements the following functions by executing a program PG2b stored in the memory 202b. The processor 201b implements various functions including functions of the acquisition unit 211a, a detection unit 212b, a calculation unit 213b, and the remote control unit 214.

The calculation unit 213b executes the first calculation process and the second calculation process on a plurality of pieces of three-dimensional point cloud data PD acquired by the acquisition unit 211a to calculate the positions and orientations of the vehicle 100 at different timings. Hereinafter, the positions and orientations of the vehicle 100 calculated by executing the first calculation process will also be referred to as “first calculation results”. The positions and orientations of the vehicle 100 calculated by executing the second calculation process will also be referred to as “second calculation results”. The calculation unit 213b arranges a plurality of first calculation results at the different timings in chronological order. Thus, the calculation unit 213b generates first time series data on the positions and orientations of the vehicle 100 calculated by executing the first calculation process. The calculation unit 213b arranges a plurality of second calculation results at the different timings in chronological order. Thus, the calculation unit 213b generates second time series data on the positions and orientations of the vehicle 100 calculated by executing the second calculation process.

The detection unit 212b detects, using the first calculation results and the second calculation results, that at least one of the pieces of three-dimensional point cloud data PD is defective. For example, the detection unit 212b detects, using the first time series data and the second time series data, that at least one of the pieces of three-dimensional point cloud data PD acquired by the acquisition unit 211a is defective. In the present embodiment, the detection unit 212b detects that the three-dimensional point cloud data PD is defective when the variation in at least either of the positions and orientations at the individual timings in at least either of the first time series data and the second time series data is equal to or larger than the variation threshold.

When the detection unit 212b detects that at least one of the pieces of three-dimensional point cloud data PD is defective, the calculation unit 213b executes the following process using the first time series data and the second time series data. In this case, the calculation unit 213b selects, as the vehicle position information to be output, either of the first calculation results and the second calculation results calculated by executing the first calculation process and the second calculation process, respectively. When the three-dimensional point cloud data PD is defective and the accuracy of matching between the three-dimensional point cloud data PD and the reference point cloud data decreases to cause a decrease in the accuracy of the position and orientation of the vehicle 100, variation may occur in the positions and orientations of the vehicle 100 at the individual timings in the first time series data. When the accuracy of the position and orientation of the vehicle 100 calculated by applying the graphic data FG to the three-dimensional point cloud data PD decreases due to the situation of detection of the vehicle 100, etc., variation may occur in the positions and orientations of the vehicle 100 at the individual timings in the second time series data. In the present embodiment, the calculation unit 213b makes selection out of the first calculation results and the second calculation results to output, as the vehicle position information, calculation results corresponding to time series data with smaller variation in the positions and orientations at the individual timings in the time series data when the first time series data is compared with the second time series data. For example, when the variation in the positions and orientations at the individual timings in the second time series data is smaller than the variation in the positions and orientations at the individual timings in the first time series data, the calculation unit 213b makes the following selection. In this case, the calculation unit 213b selects the second calculation results.

The calculation unit 213b outputs the selected calculation results as the vehicle position information. At this time, the calculation unit 213b may output, for example, a predetermined calculation result as the vehicle position information among the plurality of calculation results used to generate the time series data. The calculation unit 213b may select, as the vehicle position information to be output, either of the first calculation results and the second calculation results calculated by executing the first calculation process and the second calculation process, respectively, then execute the selected calculation process again to acquire a new calculation result, and output the newly acquired calculation result as the vehicle position information.

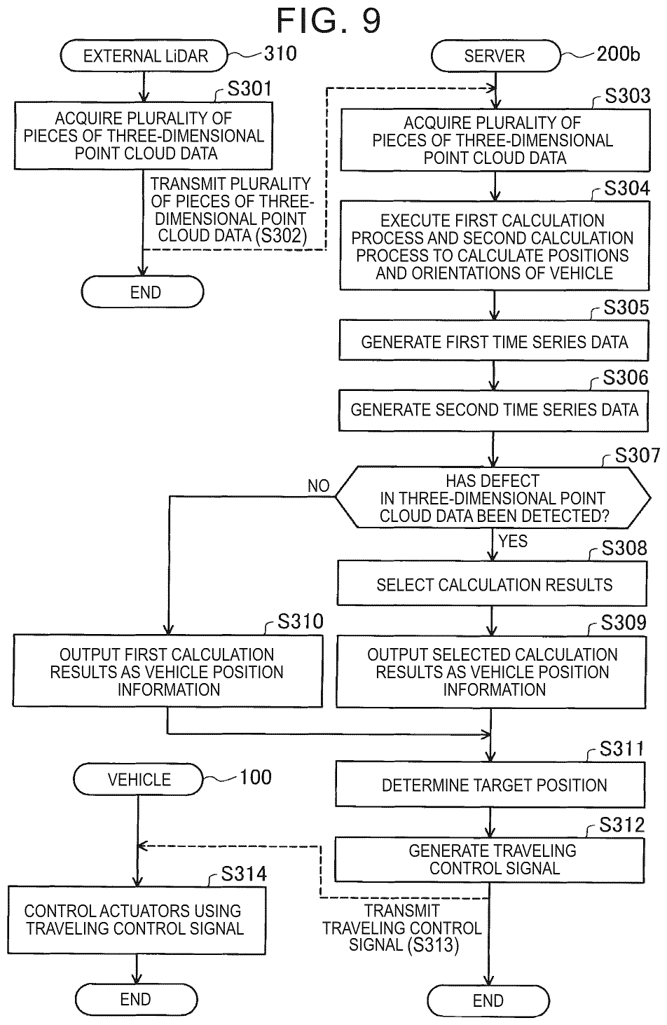

FIG. 9 is a flowchart showing a processing procedure according to the third embodiment. The flow shown in FIG. 9 is repeated at predetermined time intervals, for example, during a period in which the vehicle 100 is traveling under the remote control of the server 200b.

In step S301, the external LiDAR 310 detects the same vehicle 100 at a plurality of different timings. Thus, the external LiDAR 310 acquires a plurality of pieces of three-dimensional point cloud data PD detected at the different timings for the same vehicle 100. In step S302, the external LiDAR 310 transmits the pieces of three-dimensional point cloud data PD to the server 200b.

In step S303, the acquisition unit 211a of the server 200b acquires the pieces of three-dimensional point cloud data PD detected at the different timings for the same vehicle 100. In step S304, the calculation unit 213b executes the first calculation process and the second calculation process on the pieces of three-dimensional point cloud data PD acquired by the acquisition unit 211a to calculate the positions and orientations of the vehicle 100 at the different timings. In step S305, the calculation unit 213b generates first time series data by arranging a plurality of first calculation results at the different timings in chronological order. In step S306, the calculation unit 213b generates second time series data by arranging a plurality of second calculation results at the different timings in chronological order. In step S307, the detection unit 212b detects, using the first time series data and the second time series data, whether at least one of the pieces of three-dimensional point cloud data PD acquired by the acquisition unit 211a is defective. When the detection unit 212b detects that at least one of the pieces of three-dimensional point cloud data PD is defective (step S307: Yes), the calculation unit 213b executes step S308. In step S308, the calculation unit 213b uses the first time series data and the second time series data to select either of the first calculation results and the second calculation results to be output as vehicle position information. In step S309, the calculation unit 213b outputs the selected calculation results out of the first calculation results and the second calculation results as the vehicle position information. When the detection unit 212b does not detect that any of the pieces of three-dimensional point cloud data PD is defective (step S307: No), the calculation unit 213b executes step S310. In step S310, the calculation unit 213b outputs the first calculation results as the vehicle position information. In step S311, the remote control unit 214 uses the vehicle position information and the reference route RR to determine a target position to which the vehicle 100 is expected to move next. In step S312, the remote control unit 214 generates a traveling control signal for causing the vehicle 100 to travel toward the determined target position. In step S313, the remote control unit 214 transmits the generated traveling control signal to the vehicle 100.

In step S314, the vehicle control unit 115 of the vehicle control device 110 controls the actuator group 120 using the received traveling control signal to cause the vehicle 100 to travel at an acceleration and a steering angle indicated by the traveling control signal.

According to the third embodiment, the calculation system 7b can detect, using the first calculation results and the second calculation results, that at least one of the pieces of three-dimensional point cloud data PD is defective. When the calculation system 7b detects that at least one of the pieces of three-dimensional point cloud data PD is defective, the calculation system 7b can select, as the vehicle position information to be output, either of the first calculation results and the second calculation results calculated by executing the first calculation process and the second calculation process, respectively. That is, when the calculation system 7b detects that at least one of the pieces of three-dimensional point cloud data PD is defective, the calculation system 7b can make selection by determining which of the first calculation results and the second calculation results are more accurate. The calculation system 7b can output the selected calculation results as the vehicle position information. With this configuration, the calculation system 7b can suppress the decrease in the accuracy of the position and orientation of the vehicle 100 when the calculation system 7b detects that at least one of the pieces of three-dimensional point cloud data PD is defective.

According to the third embodiment, the calculation system 7b can acquire a plurality of pieces of three-dimensional point cloud data PD detected at different timings for the same vehicle 100. The calculation system 7b can calculate the positions and orientations of the vehicle 100 at the different timings by executing the first calculation process and the second calculation process on the acquired pieces of three-dimensional point cloud data PD. The calculation system 7b can generate the first time series data by arranging a plurality of first calculation results at the different timings in chronological order. The calculation system 7b can generate the second time series data by arranging a plurality of second calculation results at the different timings in chronological order. Thus, the calculation system 7b can detect, using the first time series data and the second time series data, that at least one of the pieces of three-dimensional point cloud data PD is defective.

The calculation system 7b can execute the following process when the calculation system 7b detects that at least one of the pieces of three-dimensional point cloud data PD is defective. In this case, using the first time series data and the second time series data, the calculation system 7b can select, as the vehicle position information to be output, either of the first calculation results and the second calculation results calculated by executing the first calculation process and the second calculation process, respectively. That is, when the calculation system 7b detects that at least one of the pieces of three-dimensional point cloud data PD is defective, the calculation system 7b can make selection by determining which of the first calculation results and the second calculation results are more accurate using the first time series data and the second time series data. The calculation system 7b can output the selected calculation results as the vehicle position information. With this configuration, the calculation system 7b can suppress the decrease in the accuracy of the position and orientation of the vehicle 100 when the calculation system 7b detects that at least one of the pieces of three-dimensional point cloud data PD is defective.

According to the third embodiment, by comparing the variations between the first time series data and the second time series data, the calculation system 7b can select, as the vehicle position information to be output, either of the first calculation results and the second calculation results calculated by executing the first calculation process and the second calculation process, respectively.

### D. Fourth Embodiment

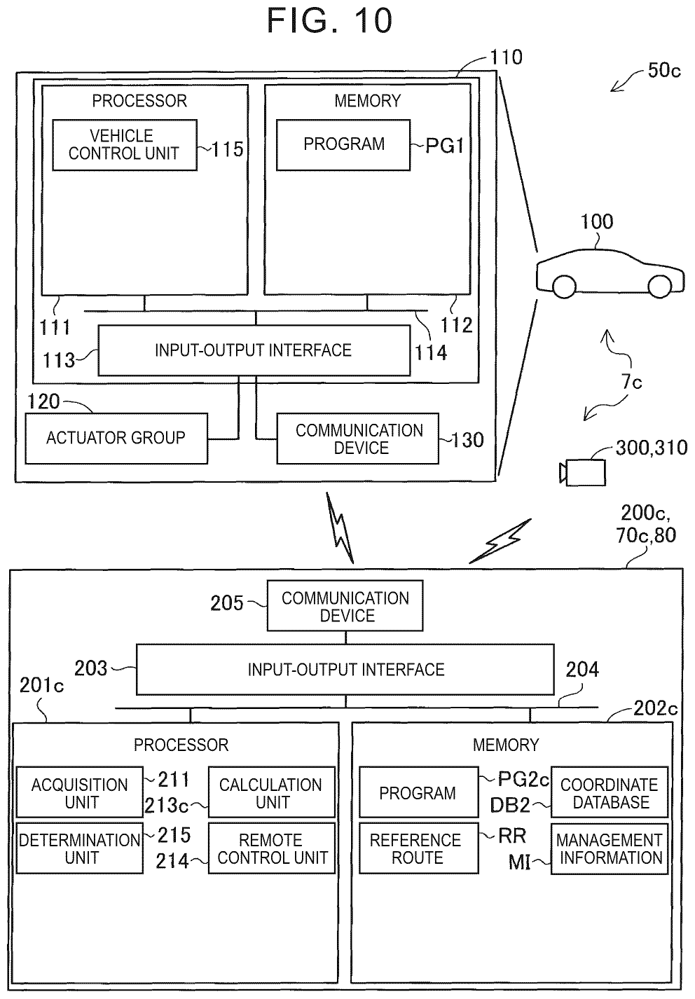

FIG. 10 is a block diagram showing the configuration of a traveling system 50c according to a fourth embodiment. The traveling system 50c includes a calculation system 7c and the remote control device 80. The calculation system 7c includes one or more vehicles 100, a calculation device 70c, and one or more external LiDARs 310. In the present embodiment, the functions of the calculation device 70c and the remote control device 80 are implemented by a server 200c. In the present embodiment, the calculation system 7c differs from the calculation system in the first embodiment in terms of the type of functional unit that acquires information on a defect in the three-dimensional point cloud data PD and the calculation method for calculating the position and orientation of the vehicle 100. The other configuration of the traveling system 50c is similar to that in the first embodiment unless otherwise specified. The same components as those in the first embodiment are represented by the same reference signs and the description thereof will be omitted.

The server 200c is a computer including a processor 201c, a memory 202c, the input-output interface 203, and the internal bus 204. The processor 201c implements the following functions by executing a program PG2c stored in the memory 202c. The processor 201c implements various functions including functions of the acquisition unit 211, a determination unit 215, a calculation unit 213c, and the remote control unit 214.

The determination unit 215 is one of the functional units that acquires information on a defect in the three-dimensional point cloud data PD. The determination unit 215 determines whether the vehicle 100 is present in a specific area where the three-dimensional point cloud data PD acquired by the acquisition unit 211 is presumed in advance to be defective. Examples of the specific area include a work area where a manufacturing step for a specific work is executed. In the specific work, a work object that is at least either of a manufacturing device to be used in the manufacturing step and a worker engaged in the work in the manufacturing step enters at least either of the interior of the vehicle 100 and the surrounding area around the vehicle 100 to carry out the work. Examples of the manufacturing device to be used in the manufacturing step include equipment to be used to assemble the vehicle 100, an automated guided vehicle that transports components etc. to be used in the manufacture of the vehicle 100, and an articulated robot that attaches the components etc. to the vehicle 100. When the vehicle 100 is present in the work area, the three-dimensional point cloud data PD may be defective due to such a work condition that the work object is present between the vehicle 100 and the external LiDAR 310. Therefore, the determination unit 215 determines whether the vehicle 100 is present in the work area as the specific area.

In the present embodiment, the determination unit 215 determines whether the vehicle 100 is present in the work area by acquiring step information indicating the manufacturing step that is being executed on the vehicle 100 and estimating the current position of the vehicle 100. The determination unit 215 acquires the step information, for example, using management information MI prestored in the memory 202c of the server 200c. The management information MI indicates the manufacturing status of the vehicle 100. Examples of the management information MI include manufacturing time information indicating timings to execute a plurality of manufacturing steps on the vehicle 100. In the manufacturing time information, a vehicle identifier, a step identifier, and a timing to execute each manufacturing step are associated with each other. The vehicle identifier is a unique identifier assigned to each of the vehicles 100 without overlaps to identify the vehicle 100. The manufacturing time information is created, for example, in accordance with a manufacturing plan for the vehicle 100, and is updated as appropriate in accordance with the progress of the manufacturing plan. For example, the determination unit 215 acquires a step identifier associated with vehicle identification information of the target vehicle 100 as the step information from the manufacturing time information.

The determination unit 215 may determine whether the vehicle 100 is present in the specific area by another method. For example, the determination unit 215 determines whether the vehicle 100 is present in the specific area by acquiring sequence information and estimating the current position of the vehicle 100. The sequence information indicates a traveling sequence of the vehicles 100 traveling within the detection ranges of the external LiDARs 310 installed in the factory FC. In the sequence information, a vehicle identifier and a sensor identifier are associated with each other. The sensor identifier is a unique identifier assigned to each of the external sensors 300 installed in the factory FC without overlaps to identify the external sensor 300. The sequence information is created, for example, using vehicle position information, a history of transmission of traveling control signals to the vehicles 100, and installation positions of the external sensors 300.

When the determination unit 215 determines that the vehicle 100 is present in the specific area, the calculation unit 213c calculates the position and orientation of the vehicle 100 by executing the second calculation process without executing the first calculation process. In this way, the calculation unit 213c acquires vehicle position information. When the determination unit 215 determines that the vehicle 100 is not present in the specific area, the calculation unit 213c calculates the position and orientation of the vehicle 100 by executing the first calculation process without executing the second calculation process. In this way, the calculation unit 213c acquires vehicle position information.

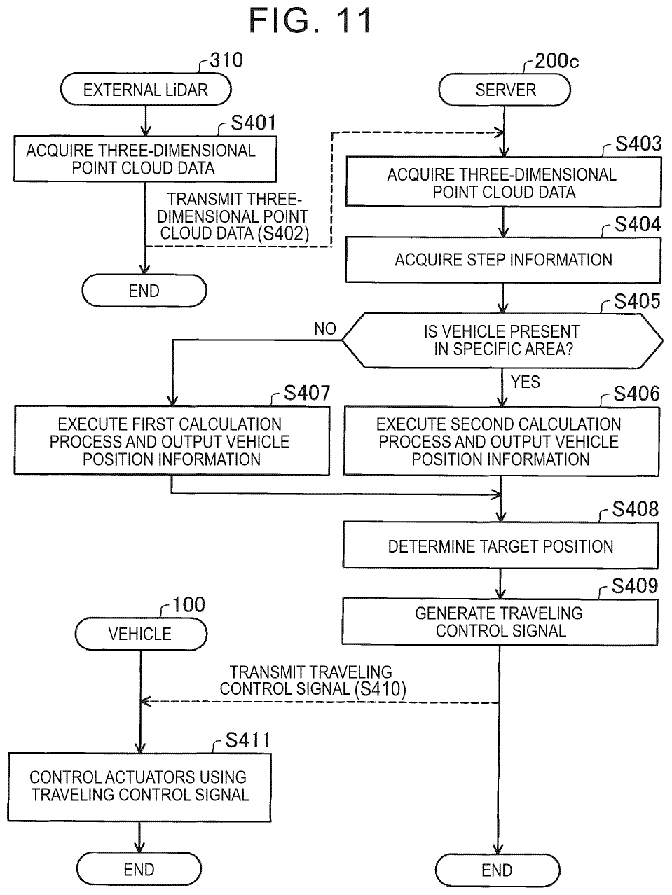

FIG. 11 is a flowchart showing a processing procedure according to the fourth embodiment. The flow shown in FIG. 11 is repeated at predetermined time intervals, for example, during a period in which the vehicle 100 is traveling under the remote control of the server 200c.

In step S401, the external LiDAR 310 acquires three-dimensional point cloud data PD. In step S402, the external LiDAR 310 transmits the three-dimensional point cloud data PD to the server 200c.

In step S403, the acquisition unit 211 of the server 200c acquires the three-dimensional point cloud data PD. In step S404, the determination unit 215 acquires step information. In step S405, the determination unit 215 determines, using the step information, whether the vehicle 100 is present in the work area by estimating the current position of the vehicle 100. When the determination unit 215 determines that the vehicle 100 is present in the work area (step S405: Yes), the calculation unit 213c executes the second calculation process without executing the first calculation process in step S406 to calculate the position and orientation of the vehicle 100, and outputs vehicle position information. When the determination unit 215 determines that the vehicle 100 is not present in the specific area (step S405: No), the calculation unit 213c executes step S407. In step S407, the calculation unit 213c executes the first calculation process without executing the second calculation process to calculate the position and orientation of the vehicle 100, and outputs vehicle position information. In step S408, the remote control unit 214 uses the vehicle position information and the reference route RR to determine a target position to which the vehicle 100 is expected to move next. In step S409, the remote control unit 214 generates a traveling control signal for causing the vehicle 100 to travel toward the determined target position. In step S410, the remote control unit 214 transmits the generated traveling control signal to the vehicle 100.

In step S411, the vehicle control unit 115 of the vehicle control device 110 controls the actuator group 120 using the received traveling control signal to cause the vehicle 100 to travel at an acceleration and a steering angle indicated by the traveling control signal.

According to the fourth embodiment, the calculation system 7c can determine whether the vehicle 100 is present in the specific area where the three-dimensional point cloud data PD is presumed in advance to be defective. When the calculation system 7c determines that the vehicle 100 is present in the specific area, the calculation system 7c can calculate the position and orientation of the vehicle 100 by executing at least the second calculation process. With this configuration, the calculation system 7c can suppress the decrease in the accuracy of the position and orientation of the vehicle 100 when the three-dimensional point cloud data PD may be defective due to the presence of the vehicle 100 in the specific area.

According to the fourth embodiment, the calculation system 7c can determine whether the vehicle 100 is present in the work area where the three-dimensional point cloud data PD may be defective when the three-dimensional point cloud data PD is acquired.

According to the fourth embodiment, the calculation system 7c can determine whether the vehicle 100 is present in the specific area by acquiring the step information using the management information MI.

According to the fourth embodiment, the calculation system 7c can determine whether the vehicle 100 is present in the specific area by estimating the current position of the vehicle 100 using the sequence information.

According to the fourth embodiment, when the calculation system 7c determines that the vehicle 100 is present in the specific area, the calculation system 7c can calculate the position and orientation of the vehicle 100 by executing the second calculation process without executing the first calculation process. Thus, it is possible to reduce the processing load when calculating the position and orientation of the vehicle 100.

The specific area may include areas other than the work area in addition to or instead of the work area. The specific area may include, for example, a parking area such as a yard where the manufactured vehicles 100 are parked and stored. When the vehicle 100 is present in the parking area, the three-dimensional point cloud data PD may be defective due to such a layout of the vehicles 100 that another vehicle 100 is present between the vehicle 100 and the external LiDAR 310. Therefore, the determination unit 215 may determine whether the vehicle 100 is present in the parking area as the specific area. With this configuration, the calculation system 7c can determine whether the vehicle 100 is present in the parking area where the three-dimensional point cloud data PD may be defective when the three-dimensional point cloud data PD is acquired.

### E. Fifth Embodiment

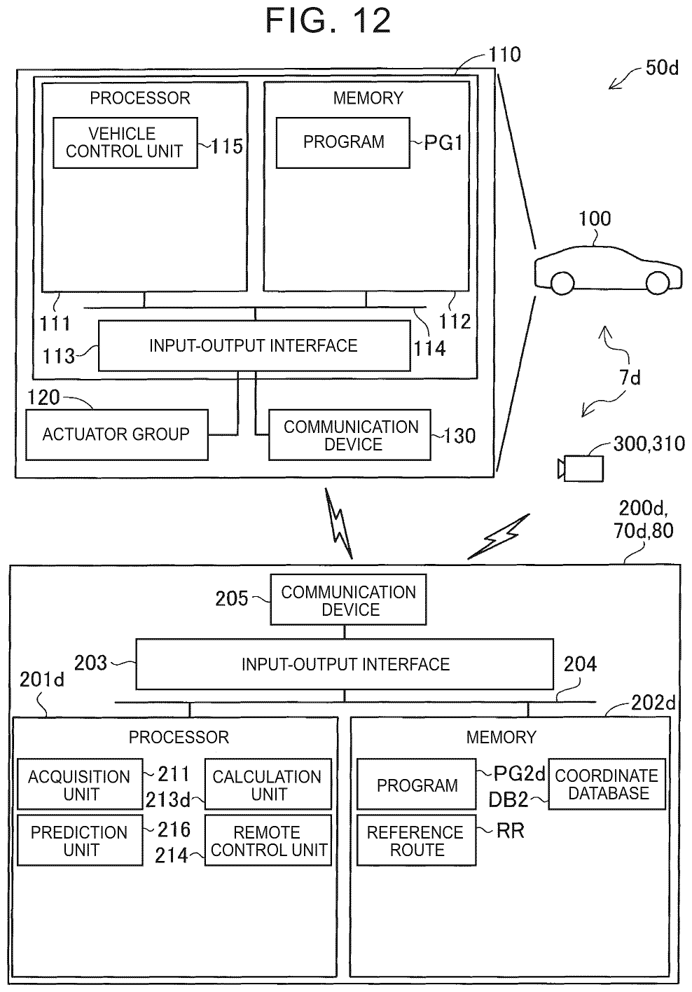

FIG. 12 is a block diagram showing the configuration of a traveling system 50d according to a fifth embodiment. The traveling system 50d includes a calculation system 7d and the remote control device 80. The calculation system 7d includes one or more vehicles 100, a calculation device 70d, and one or more external LiDARs 310. In the present embodiment, the functions of the calculation device 70d and the remote control device 80 are implemented by a server 200d. In the present embodiment, the calculation system 7d differs from the calculation system in the first embodiment in terms of the type of functional unit that acquires information on a defect in the three-dimensional point cloud data PD and the calculation method for calculating the position and orientation of the vehicle 100. The other configuration of the traveling system 50d is similar to that in the first embodiment unless otherwise specified. The same components as those in the first embodiment are represented by the same reference signs and the description thereof will be omitted.

The server 200d is a computer including a processor 201d, a memory 202d, the input-output interface 203, and the internal bus 204. The processor 201d implements the following functions by executing a program PG2d stored in the memory 202d. The processor 201d implements various functions including functions of the acquisition unit 211, a prediction unit 216, a calculation unit 213d, and the remote control unit 214.

The prediction unit 216 is one of the functional units that acquires information on a defect in the three-dimensional point cloud data PD. The prediction unit 216 predicts that the three-dimensional point cloud data PD will be defective before the three-dimensional point cloud data PD is acquired.

The prediction unit 216 predicts that the three-dimensional point cloud data PD will be defective, for example, using object information. The object information is information on at least either of an object present in a first area where a first manufacturing step is executed and an object present in a second area where a second manufacturing step is executed. The first manufacturing step is a manufacturing step that is being executed on the vehicle 100. The second manufacturing step is a manufacturing step to be executed on the vehicle 100 after the first manufacturing step. Examples of the object information include information indicating the numbers and layouts of objects present in the first area and in the second area. The object information may be, for example, the number of workers engaged in the manufacturing step, the layout of manufacturing devices that execute a specific work, or the range of motion of a manufacturing device such as an articulated robot. The object information may be, for example, information indicating traveling positions of other vehicles 100.

The prediction unit 216 may predict that the three-dimensional point cloud data PD will be defective by another method. The prediction unit 216 may predict that the three-dimensional point cloud data PD will be defective, for example, using work information. The work information indicates whether a specific work is to be executed in at least either of the first manufacturing step and the second manufacturing step.

When the prediction unit 216 predicts that the three-dimensional point cloud data PD will be defective, the calculation unit 213d executes at least the second calculation process. In the present embodiment, when the prediction unit 216 predicts that the three-dimensional point cloud data PD will be defective, the calculation unit 213d executes the second calculation process without executing the first calculation process to calculate the position and orientation of the vehicle 100, and outputs vehicle position information. When the prediction unit 216 predicts that the three-dimensional point cloud data PD will not be defective, the calculation unit 213d executes the first calculation process without executing the second calculation process to calculate the position and orientation of the vehicle 100, and outputs vehicle position information.

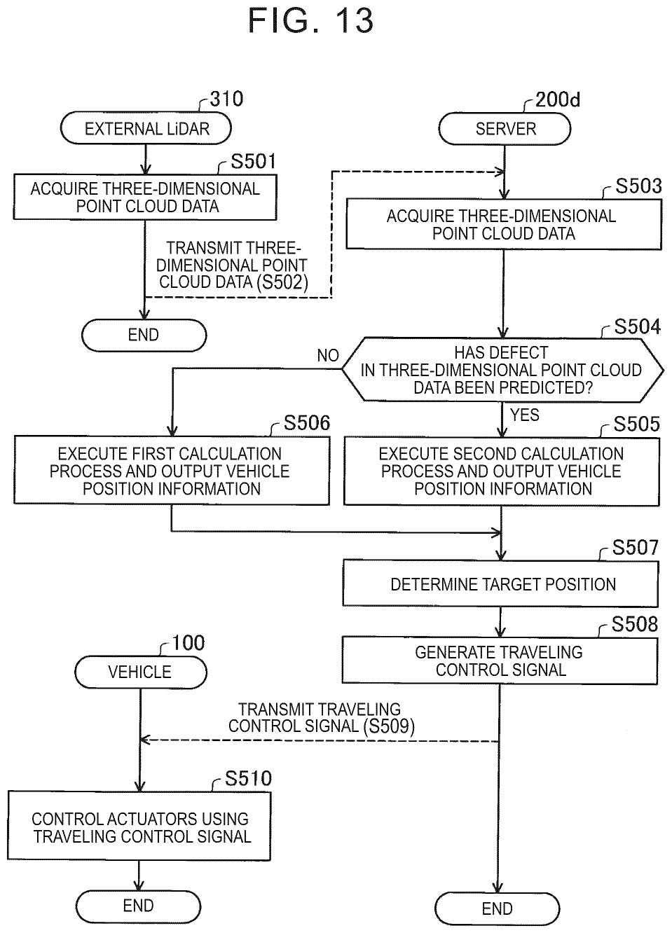

FIG. 13 is a flowchart showing a processing procedure according to the fifth embodiment. The flow shown in FIG. 13 is repeated at predetermined time intervals, for example, during a period in which the vehicle 100 is traveling under the remote control of the server 200d.

In step S501, the external LiDAR 310 acquires three-dimensional point cloud data PD. In step S502, the external LiDAR 310 transmits the three-dimensional point cloud data PD to the server 200d.

In step S503, the acquisition unit 211 of the server 200d acquires the three-dimensional point cloud data PD. In step S504, the prediction unit 216 predicts whether the three-dimensional point cloud data PD will be defective. When the prediction unit 216 predicts that the three-dimensional point cloud data PD will be defective (step S504: Yes), the calculation unit 213d executes step S505. In step S505, the calculation unit 213d executes the second calculation process without executing the first calculation process to calculate the position and orientation of the vehicle 100, and outputs vehicle position information. When the prediction unit 216 predicts that the three-dimensional point cloud data PD will not be defective (step S504: No), the calculation unit 213d executes step S506. In step S506, the calculation unit 213d executes the first calculation process without executing the second calculation process to calculate the position and orientation of the vehicle 100, and outputs vehicle position information. In step S507, the remote control unit 214 uses the vehicle position information and the reference route RR to determine a target position to which the vehicle 100 is expected to move next. In step S508, the remote control unit 214 generates a traveling control signal for causing the vehicle 100 to travel toward the determined target position. In step S509, the remote control unit 214 transmits the generated traveling control signal to the vehicle 100.

In step S510, the vehicle control unit 115 of the vehicle control device 110 controls the actuator group 120 using the received traveling control signal to cause the vehicle 100 to travel at an acceleration and a steering angle indicated by the traveling control signal.

According to the fifth embodiment, the calculation system 7d can predict that the three-dimensional point cloud data PD will be defective before the three-dimensional point cloud data PD is acquired. When the calculation system 7d predicts that the three-dimensional point cloud data PD will be defective, the calculation system 7d can calculate the position and orientation of the vehicle 100 by executing at least the second calculation process. With this configuration, the calculation system 7d can suppress the decrease in the accuracy of the position and orientation of the vehicle 100 when the three-dimensional point cloud data PD is predicted to be defective.

According to the fifth embodiment, the calculation system 7d can predict that the three-dimensional point cloud data PD will be defective using at least either of the object information and the work information.

### F. Sixth Embodiment

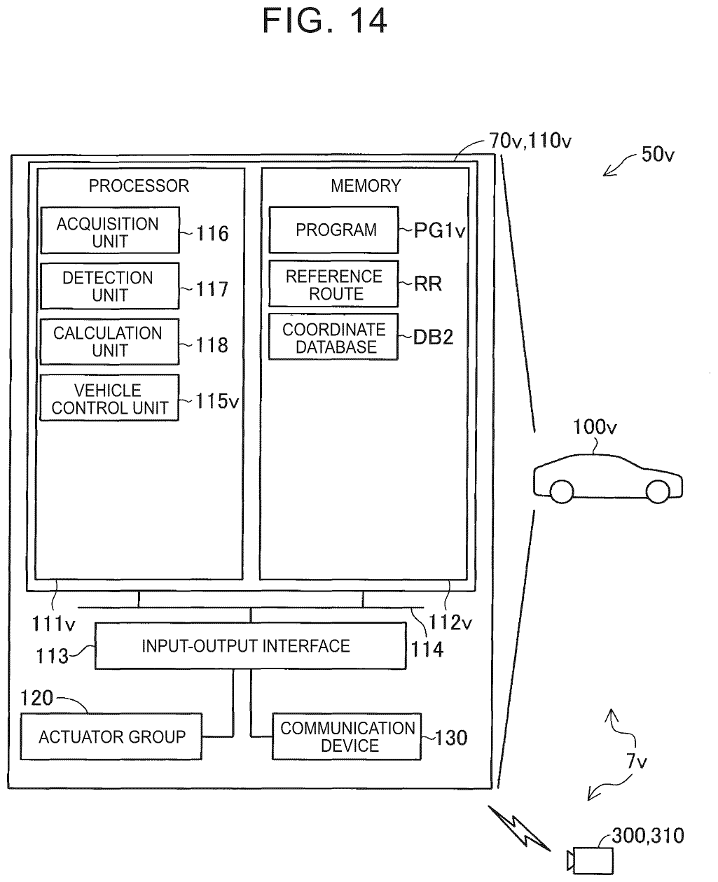

FIG. 14 is a block diagram showing the configuration of a traveling system 50v according to a sixth embodiment. The traveling system 50v includes a calculation system 7v. The calculation system 7v includes one or more vehicles 100 and one or more external LiDARs 310. The present embodiment differs from the first embodiment in that the traveling system 50v does not include the server 200. The functions of the calculation device 70v are implemented by a vehicle control device 110v. A vehicle 100v in the present embodiment can travel by autonomous control on the vehicle 100v. The other configuration is similar to that in the first embodiment unless otherwise specified.

In the present embodiment, a processor 111v of the vehicle control device 110v functions as an acquisition unit 116, a detection unit 117, a calculation unit 118, and a vehicle control unit 115v by executing a program PG1v stored in a memory 112v. The acquisition unit 116 acquires three-dimensional point cloud data PD obtained by detecting the vehicle 100v from the outside using the external LiDAR 310. The detection unit 117 detects that the three-dimensional point cloud data PD acquired by the acquisition unit 116 is defective. The calculation unit 118 uses the three-dimensional point cloud data PD to calculate the position and orientation of the vehicle 100v, and outputs vehicle position information. When the detection unit 117 detects that the three-dimensional point cloud data PD is defective, the calculation unit 118 executes at least the second calculation process to calculate the position and orientation of the vehicle 100v, and outputs vehicle position information. When the detection unit 117 does not detect that the three-dimensional point cloud data PD is defective, the calculation unit 118 executes the first calculation process without executing the second calculation process to calculate the position and orientation of the vehicle 100v, and outputs vehicle position information. The vehicle control unit 115v acquires output results from the sensors, generates a traveling control signal using the output results, and outputs the generated traveling control signal to operate the actuator group 120. Thus, the vehicle 100v can travel by autonomous control. In the present embodiment, the memory 112v prestores a detection model and the reference route RR in addition to the program PG1v.

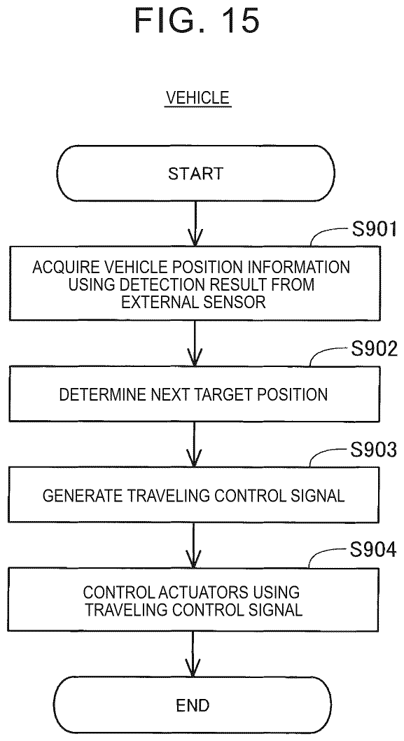

FIG. 15 is a flowchart showing a processing procedure of the traveling control on the vehicle 100v according to the sixth embodiment. The flow shown in FIG. 15 is repeated at predetermined time intervals, for example, during a period in which the vehicle 100v is traveling by autonomous control. In the processing procedure of FIG. 15, the processor 111v of the vehicle 100v executes the program PG1v to function as the acquisition unit 116, the detection unit 117, the calculation unit 118, and the vehicle control unit 115v.

In step S901, the processor 111v of the vehicle control device 110v acquires vehicle position information using a detection result output from the external LiDAR 310 that is the external sensor 300. In step S902, the processor 111v determines a target position to which the vehicle 100v is expected to move next. In step S903, the processor 111v generates a traveling control signal for causing the vehicle 100v to travel toward the determined target position. In step S904, the processor 111v controls the actuator group 120 using the generated traveling control signal to cause the vehicle 100v to travel based on parameters indicated by the traveling control signal. The processor 111v repeats, at a predetermined cycle, the acquisition of the vehicle position information, the determination of the target position, the generation of the traveling control signal, and the control on the actuators. With the traveling system 50v according to the present embodiment, the vehicle 100v can travel by autonomous control on the vehicle 100v even if the vehicle 100v is not remotely controlled by the server 200.

### G. Other Embodiments

### G-1. First Other Embodiment

At least part of the functions of the server 200, 200a to 200d may be a function of the vehicle control device 110, 110v or may be a function of the external sensor 300. At least part of the functions of the vehicle control device 110, 110v may be a function of the server 200, 200a to 200d or may be a function of the external sensor 300. That is, the calculation device 70, 70a to 70d, 70v including the acquisition unit 116, 211, 211a, at least one functional unit out of the prediction unit 216, the detection unit 117, 212, 212a, 212b, and the determination unit 215, and the calculation unit 118, 213, 213a to 213d may be the server 200, 200a to 200d or may be the vehicle control device 110, 110v. With such an embodiment, the configuration of the calculation system 7, 7a to 7d, 7v can be changed as appropriate.

### G-2. Second Other Embodiment

The calculation system 7, 7a to 7d, 7v only needs to include at least one functional unit out of the prediction unit 216, the detection unit 117, 212, 212a, 212b, and the determination unit 215. For example, the calculation system 7, 7a to 7d, 7v may include three functional units that are the prediction unit 216, the detection unit 117, 212, 212a, 212b, and the determination unit 215. In this case, the calculation unit 118, 213, 213a to 213d calculates at least either of the position and the orientation of the vehicle 100, 100v by executing at least the second calculation process when at least one of first, second, and third cases applies. The first case is a case where the prediction unit 216 predicts that the three-dimensional point cloud data PD will be defective. The second case is a case where the detection unit 117, 212, 212a, 212b detects that the three-dimensional point cloud data PD is defective. The third case is a case where the determination unit 215 determines that the vehicle 100, 100v is present in the specific area. With such an embodiment, the calculation system 7, 7a to 7d, 7v can suppress the decrease in the accuracy of the position and orientation of the vehicle 100, 100v in both the cases where the three-dimensional point cloud data PD is predicted to be defective and where the three-dimensional point cloud data PD is defective.

### G-3. Third Other Embodiment

In each of the above embodiments, the traveling system 50, 50a to 50d, 50v includes the external LiDAR 310 as the external sensor 300. The traveling system 50, 50a to 50d, 50v may further include, for example, a camera as the external sensor 300. The camera serving as the external sensor 300 captures an image of the vehicle 100, 100v and outputs the captured image as a detection result. When acquiring vehicle position information using the captured image acquired from the camera serving as the external sensor 300, the calculation unit 118, 213, 213a to 213d acquires the position of the vehicle 100, 100v, for example, by detecting the outer shape of the vehicle 100, 100v from the captured image, calculating the coordinates of the positioning point of the vehicle 100, 100v in a coordinate system of the captured image, that is, a local coordinate system, and converting the calculated coordinates into coordinates in the global coordinate system GC. The outer shape of the vehicle 100, 100v in the captured image can be detected, for example, by inputting the captured image to a detection model using artificial intelligence. The detection model is prepared, for example, inside or outside the traveling system 50, 50a to 50d, 50v, and is prestored in the memory 112, 112v, 202, 202a to 202d. Examples of the detection model include a trained machine learning model that has been trained to achieve either of semantic segmentation and instance segmentation. For example, a convolutional neural network (hereinafter referred to as “CNN”) trained through supervised learning using a learning data set can be used as the machine learning model. The learning data set includes, for example, a plurality of training images including the vehicle 100, 100v, and a label indicating whether each area in the training images is an area indicating the vehicle 100, 100v or an area indicating a field other than the vehicle 100, 100v. During training of the CNN, parameters of the CNN are preferably updated to reduce a deviation between the result output from the detection model and the label through backpropagation. The calculation unit 118, 213, 213a to 213d can acquire the orientation of the vehicle 100, 100v by estimating the orientation, for example, based on the direction of a movement vector of the vehicle 100, 100v calculated from variations in position of feature points of the vehicle 100, 100v between frames of the captured image using an optical flow method.

### G-4. Fourth Other Embodiment

In each of the first to fifth embodiments, the server 200, 200a to 200d executes the process from the acquisition of the vehicle position information to the generation of the traveling control signal. The vehicle 100 may execute at least part of the process from the acquisition of the vehicle position information to the generation of the traveling control signal. For example, the following aspects (1) to (3) may be used.

(1) The server 200, 200a to 200d may acquire vehicle position information, determine a target position to which the vehicle 100 is expected to move next, and generate a route from the current position of the vehicle 100 indicated by the acquired vehicle position information to the target position. The server 200, 200a to 200d may generate a route to the target position between the current position and a destination, or may generate a route to the destination. The server 200, 200a to 200d may transmit the generated route to the vehicle 100. The vehicle 100 may generate a traveling control signal so that the vehicle 100 travels on the route received from the server 200, 200a to 200d, and control the actuator group 120 using the generated traveling control signal.

(2) The server 200, 200a to 200d may acquire vehicle position information and transmit the acquired vehicle position information to the vehicle 100. The vehicle 100 may determine a target position to which the vehicle 100 is expected to move next, generate a route from the current position of the vehicle 100 indicated by the received vehicle position information to the target position, generate a traveling control signal so that the vehicle 100 travels on the generated route, and control the actuator group 120 using the generated traveling control signal.

(3) In the above aspects (1) and (2), an internal sensor may be mounted on the vehicle 100 and a detection result output from the internal sensor may be used in at least either of the generation of the route and the generation of the traveling control signal. The internal sensor is a sensor mounted on the vehicle 100. Examples of the internal sensor may include a sensor that detects the motion state of the vehicle 100, a sensor that detects the operating state of each part of the vehicle 100, and a sensor that detects the environment around the vehicle 100. Specific examples of the internal sensor may include a camera, a LiDAR, a millimeter wave radar, an ultrasonic sensor, a global positioning system (GPS) sensor, an acceleration sensor, and a gyro sensor. For example, in the above aspect (1), the server 200, 200a to 200d may acquire a detection result from the internal sensor and reflect the detection result from the internal sensor in a route when generating the route. In the above aspect (1), the vehicle 100 may acquire a detection result from the internal sensor and reflect the detection result from the internal sensor in a traveling control signal when generating the traveling control signal. In the above aspect (2), the vehicle 100 may acquire a detection result from the internal sensor and reflect the detection result from the internal sensor in a route when generating the route. In the above aspect (2), the vehicle 100 may acquire a detection result from the internal sensor and reflect the detection result from the internal sensor in a traveling control signal when generating the traveling control signal.

### G-5. Fifth Other Embodiment

In the sixth embodiment, an internal sensor may be mounted on the vehicle 100v and a detection result output from the internal sensor may be used in at least either of the generation of the route and the generation of the traveling control signal. For example, the vehicle 100v may acquire a detection result from the internal sensor and reflect the detection result from the internal sensor in a route when generating the route. The vehicle 100v may acquire a detection result from the internal sensor and reflect the detection result from the internal sensor in a traveling control signal when generating the traveling control signal.

### G-6. Sixth Other Embodiment

In the sixth embodiment, the vehicle 100v acquires the vehicle position information using the detection result from the external sensor 300. An internal sensor may be mounted on the vehicle 100v, and the vehicle 100v may acquire vehicle position information using a detection result from the internal sensor, determine a target position to which the vehicle 100v is expected to move next, generate a route from the current position of the vehicle 100v indicated by the acquired vehicle position information to the target position, generate a traveling control signal so that the vehicle 100v travels on the generated route, and control the actuator group 120 using the generated traveling control signal. In this case, the vehicle 100v can travel without using the detection result from the external sensor 300. The vehicle 100v may acquire a target arrival time and traffic congestion information from the outside of the vehicle 100v, and reflect the target arrival time or the traffic congestion information in at least either of the route and the traveling control signal. All the functional components of the traveling system 50v may be provided in the vehicle 100v. That is, the process implemented by the traveling system 50v in the present disclosure may be implemented by the vehicle 100v alone.

### G-7. Seventh Other Embodiment

In each of the first to fifth embodiments, the server 200, 200a to 200d automatically generates the traveling control signal to be transmitted to the vehicle 100. The server 200, 200a to 200d may generate the traveling control signal to be transmitted to the vehicle 100 in response to an operation by an external operator outside the vehicle 100. For example, the external operator may operate a manipulation device including a display that displays a captured image output from the external sensor 300, a steering wheel, an accelerator pedal, and a brake pedal that are used to remotely operate the vehicle 100, and a communication device that communicates with the server 200, 200a to 200d by wired or wireless communication, and the server 200, 200a to 200d may generate a traveling control signal in response to an operation performed on the manipulation device.

### G-8. Eighth Other Embodiment

In each of the above embodiments, the vehicle 100, 100v only needs to include components that enable movement by driverless operation, and may be, for example, in the form of a platform including the following components. Specifically, the vehicle 100, 100v only needs to include at least the vehicle control device 110, 110v and the actuator group 120 to implement three functions including “running”, “turning”, and “stopping” by driverless operation. In order for the vehicle 100, 100v to acquire information from the outside for driverless operation, the vehicle 100, 100v only needs to include the communication device 130. That is, at least part of interior components such as a driver's seat or a dashboard, at least part of exterior components such as a bumper or a fender, or a body shell may be omitted from the vehicle 100, 100v that is movable by driverless operation. In this case, the remaining components such as a body shell may be mounted on the vehicle 100, 100v before the vehicle 100, 100v is shipped from the factory FC, or the remaining components such as a body shell may be mounted on the vehicle 100, 100v after the vehicle 100, 100v is shipped from the factory FC with no remaining components such as a body shell mounted on the vehicle 100, 100v. The components may be mounted on the vehicle 100, 100v from any side such as the upper side, the lower side, the front side, the rear side, the right side, or the left side, and may be mounted from the same side or from different sides. Also in the form of a platform, the position may be determined as with the vehicle 100, 100v according to the first embodiment.

### G-9. Ninth Other Embodiment

The vehicle 100, 100v may be manufactured by combining a plurality of modules. The modules each mean a unit composed of a plurality of components grouped according to the area or the function in the vehicle 100, 100v. For example, the platform of the vehicle 100, 100v may be manufactured by combining a front module constituting a front part of the platform, a central module constituting a central part of the platform, and a rear module constituting a rear part of the platform. The number of modules constituting the platform is not limited to three, and may be two or less or four or more. The modules may include a component constituting a portion of the vehicle 100, 100v that is different from the platform in addition to or instead of the components constituting the platform. The various modules may include any exterior component such as a bumper or a grille, or any interior component such as a seat or a console. Not only the vehicle 100, 100v but also mobile objects in any forms may be manufactured by combining a plurality of modules. For example, such modules may be manufactured by joining a plurality of components by welding, using a fixture, etc., or may be manufactured by integrally molding at least part of components constituting a module as a single component by casting. The method of integrally molding a single component, in particular a relatively large component, is called gigacasting or megacasting. For example, the front module, the central module, and the rear module may be manufactured by gigacasting.

### G-10. Tenth Other Embodiment

Transport of the vehicle 100, 100v using traveling of the vehicle 100, 100v by driverless operation is called “self-propelled transport”. The configuration for implementing the self-propelled transport is called “vehicle remote control autonomous transport system”. The method of producing the vehicle 100, 100v using the self-propelled transport is called “self-propelled production”. In the self-propelled production, for example, at least part of the transport of the vehicle 100, 100v in the factory FC that manufactures the vehicle 100, 100v is implemented by the self-propelled transport.

### G-11. Eleventh Other Embodiment

In each of the above embodiments, part or all of the functions and processes implemented by software may be implemented by hardware. Part or all of the functions and processes implemented by hardware may be implemented by software. Various circuits such as integrated circuits and discrete circuits may be used as the hardware for implementing the various functions in each of the above embodiments.

The present disclosure is not limited to the above embodiments, and can be implemented by a variety of configurations without departing from the spirit of the present disclosure. For example, the technical features in each embodiment corresponding to the technical features in each aspect described in “SUMMARY” can be replaced or combined as appropriate in order to solve some or all of the above issues or achieve some or all of the above effects. When the technical features are not described as being essential herein, these features can be omitted as appropriate.

What is claimed is:

1. A calculation device comprising:
an acquisition unit configured to acquire three-dimensional point cloud data indicating, by a point cloud, a mobile object movable by driverless operation;
a calculation unit configured to calculate at least either of a position and an orientation of the mobile object using the three-dimensional point cloud data; and
at least one of a prediction unit configured to predict that the three-dimensional point cloud data is expected to be defective, a detection unit configured to detect that the three-dimensional point cloud data is defective, and a determination unit configured to determine whether the mobile object is present in a specific area where the three-dimensional point cloud data is presumed in advance to be defective, wherein:
the calculation unit is configured to execute a first calculation process of calculating at least either of the position and the orientation of the mobile object by comparing the three-dimensional point cloud data with reference point cloud data prepared in advance, and a second calculation process of calculating at least either of the position and the orientation of the mobile object by applying graphic data having a predetermined shape to the three-dimensional point cloud data; and
the calculation unit is configured to execute at least the second calculation process when at least one of a first case, a second case, and a third case applies, the first case being a case where the prediction unit predicts that the three-dimensional point cloud data is expected to be defective, the second case being a case where the detection unit detects that the three-dimensional point cloud data is defective, the third case being a case where the determination unit determines that the mobile object is present in the specific area.

2. The calculation device according to claim 1, wherein the prediction unit is configured to predict that the three-dimensional point cloud data is expected to be defective using at least either of:
object information on at least either of an object present in a first area where a first manufacturing step is being executed on the mobile object and an object present in a second area where a second manufacturing step is to be executed on the mobile object; and
work information indicating whether a specific work is to be executed in at least either of the first manufacturing step and the second manufacturing step, the specific work being a work in which a work object that is at least either of a manufacturing device to be used in the at least either of the first manufacturing step and the second manufacturing step and a worker engaged in the work in the at least either of the first manufacturing step and the second manufacturing step enters at least either of an interior of the mobile object and a surrounding area around the mobile object to carry out the work.

3. The calculation device according to claim 1, wherein the specific area is an area where a specific work is executed, the specific work being a work in which a work object that is at least either of a manufacturing device to be used in a manufacturing step of the mobile object and a worker engaged in the work in the manufacturing step enters at least either of an interior of the mobile object and a surrounding area around the mobile object to carry out the work.

4. The calculation device according to claim 1, wherein the detection unit is configured to detect that the three-dimensional point cloud data is defective when a count of points constituting the three-dimensional point cloud data is smaller than a predetermined count.

5. The calculation device according to claim 1, wherein the detection unit is configured to detect that the three-dimensional point cloud data is defective when an object is detected in the three-dimensional point cloud data between the mobile object and a mobile object detection device configured to output the three-dimensional point cloud data by detecting the mobile object from outside the mobile object.

6. The calculation device according to claim 1, wherein:
the acquisition unit is configured to acquire a plurality of pieces of the three-dimensional point cloud data detected at different timings for the same mobile object;
the calculation unit is configured to calculate at least either of the positions and the orientations of the mobile object at the different timings by executing the first calculation process on the pieces of the three-dimensional point cloud data, and generate time series data on at least either of the positions and the orientations of the mobile object by arranging at least either of the positions and the orientations of the mobile object in chronological order;
the detection unit is configured to detect, using the time series data, that at least one of the pieces of the three-dimensional point cloud data is defective; and
the calculation unit is configured to, when the detection unit detects that at least one of the pieces of the three-dimensional point cloud data is defective, calculate at least either of the position and the orientation of the mobile object by executing the second calculation process without executing the first calculation process.

7. The calculation device according to claim 1, wherein, when at least one of the first case, the second case, and the third case applies,
the calculation unit executes the first calculation process and the second calculation process,
the calculation unit calculates the position of the mobile object by executing a first arithmetic process using the position of the mobile object calculated by executing the first calculation process and the position of the mobile object calculated by executing the second calculation process, and
the calculation unit calculates the orientation of the mobile object by executing a second arithmetic process using the orientation of the mobile object calculated by executing the first calculation process and the orientation of the mobile object calculated by executing the second calculation process.

8. A calculation system comprising:
the mobile object;
a mobile object detection device configured to output the three-dimensional point cloud data by detecting the mobile object from outside the mobile object; and
the calculation device according to claim 1.

9. A calculation method comprising:
an acquisition step of acquiring three-dimensional point cloud data indicating, by a point cloud, a mobile object movable by driverless operation;
a calculation step of calculating at least either of a position and an orientation of the mobile object using the three-dimensional point cloud data; and
at least one of a prediction step of predicting that the three-dimensional point cloud data is expected to be defective, a detection step of detecting that the three-dimensional point cloud data is defective, and a determination step of determining whether the mobile object is present in a specific area where the three-dimensional point cloud data is presumed in advance to be defective, wherein:
in the calculation step, a first calculation process is executable to calculate at least either of the position and the orientation of the mobile object by comparing the three-dimensional point cloud data with reference point cloud data prepared in advance, and a second calculation process is executable to calculate at least either of the position and the orientation of the mobile object by applying graphic data having a predetermined shape to the three-dimensional point cloud data; and
in the calculation step, at least the second calculation process is executed when at least one of a first case, a second case, and a third case applies, the first case being a case where prediction is made in the prediction step that the three-dimensional point cloud data is expected to be defective, the second case being a case where detection is made in the detection step that the three-dimensional point cloud data is defective, the third case being a case where determination is made in the determination step that the mobile object is present in the specific area.

10. A calculation device comprising:
an acquisition unit configured to acquire three-dimensional point cloud data indicating, by a point cloud, a mobile object movable by driverless operation;
a calculation unit configured to calculate at least either of a position and an orientation of the mobile object using the three-dimensional point cloud data, and output vehicle position information including at least either of the position and the orientation of the mobile object; and
a detection unit configured to detect that the three-dimensional point cloud data is defective, wherein:
the calculation unit is configured to execute a first calculation process of calculating at least either of the position and the orientation of the mobile object by comparing the three- dimensional point cloud data with reference point cloud data prepared in advance, and a second calculation process of calculating at least either of the position and the orientation of the mobile object by applying graphic data having a predetermined shape to the three-dimensional point cloud data;
the calculation unit is configured to calculate at least either of the position and the orientation of the mobile object by executing the first calculation process and the second calculation process;
the detection unit is configured to detect that the three-dimensional point cloud data is defective using a first calculation result of at least either of the position and the orientation of the mobile object calculated by executing the first calculation process and a second calculation result of at least either of the position and the orientation of the mobile object calculated by executing the second calculation process; and
the calculation unit is configured to, when the detection unit detects that the three-dimensional point cloud data is defective, select either of the first calculation result and the second calculation result as the vehicle position information to be output, and output the selected first calculation result or the selected second calculation result as the vehicle position information.

11. The calculation device according to claim 10, wherein:
the acquisition unit is configured to acquire a plurality of pieces of the three-dimensional point cloud data detected at different timings for the same mobile object;
the calculation unit is configured to calculate at least either of the positions and the orientations of the mobile object at the different timings by executing the first calculation process and the second calculation process on the pieces of the three-dimensional point cloud data;
the calculation unit is configured to generate first time series data on at least either of the positions and the orientations of the mobile object by arranging a plurality of the first calculation results at the different timings in chronological order;
the calculation unit is configured to generate second time series data on at least either of the positions and the orientations of the mobile object by arranging a plurality of the second calculation results at the different timings in chronological order;
the detection unit is configured to detect, using the first time series data and the second time series data, that at least one of the pieces of the three-dimensional point cloud data is defective; and
the calculation unit is configured to, when the detection unit detects that at least one of the pieces of the three-dimensional point cloud data is defective, use the first time series data and the second time series data to select, as the vehicle position information to be output, either of the first calculation result and the second calculation result calculated by executing the first calculation process and the second calculation process, respectively.

12. A calculation system comprising:
one or more mobile objects movable by driverless operation;
a mobile object detection device configured to output three-dimensional point cloud data indicating the mobile object by a point cloud by detecting the mobile object from outside the mobile object; and
the calculation device according to claim 10.
